(19) United States
(12) Patent Application Publication
(10) Pub. No.: US 2025/0291158 A1
(43) Pub. Date: Sep. 18, 2025

(54) IMAGING OPTICAL LENS ASSEMBLY, IMAGING APPARATUS AND ELECTRONIC DEVICE

(71) Applicant: LARGAN PRECISION CO., LTD., Taichung City (TW)

(72) Inventors: Yu-Tai TSENG, Taichung City (TW); Tzu-Chieh KUO, Taichung City (TW)

(21) Appl. No.: 19/017,962

(22) Filed: Jan. 13, 2025

(30) Foreign Application Priority Data
Mar. 13, 2024 (TW) 113109300

(51) Int. Cl. G02B 13/00; G02B 9/62; H04N 23/55

(52) U.S. Cl. CPC G02B 13/0045; G02B 9/62; G02B 13/0065; H04N 23/55

(57) ABSTRACT

An imaging optical lens assembly includes six lens elements, the six lens elements being, in order from an object side to an image side along an optical path, a first lens element, a second lens element, a third lens element, a fourth lens element, a fifth lens element and a sixth lens element. Each of the sixth lens elements has an object-side surface towards the object side and an image-side surface towards the image side. The object-side surface of the first lens element is convex in a paraxial region thereof. The object-side surface of the fourth lens element is convex in a paraxial region thereof, the image-side surface of the fourth lens element is concave in a paraxial region thereof. At least one of the second lens element to the sixth lens element includes at least one inflection point in an optical effective area thereof.

### RELATED APPLICATIONS

This application claims priority to Taiwan Application Serial Number 113109300, filed Mar. 13, 2024, which is herein incorporated by reference.

### BACKGROUND

### Technical Field

The present disclosure relates to an imaging optical lens assembly and an imaging apparatus. More particularly, the present disclosure relates to an imaging optical lens assembly and an imaging apparatus with compact size applicable to electronic devices.

### Description of Related Art

With recent technology of semiconductor process advances, performances of image sensors are enhanced, so that the smaller pixel size can be achieved. Therefore, optical lens assemblies with high image quality have become an indispensable part of many modern electronics. With rapid developments of technology, applications of electronic devices equipped with optical lens assemblies increase and there is a wide variety of requirements for optical lens assemblies. However, in a conventional optical lens assembly, it is hard to balance among image quality, sensitivity, aperture size, volume or field of view. Thus, there is a demand for an imaging optical lens assembly that meets the aforementioned needs.

### SUMMARY

According to one aspect of the present disclosure, an imaging optical lens assembly includes six lens elements, the six lens elements being, in order from an object side to an image side along an optical path, a first lens element, a second lens element, a third lens element, a fourth lens element, a fifth lens element and a sixth lens element. Each of the sixth lens elements has an object-side surface towards the object side and an image-side surface towards the image side. Preferably, the object-side surface of the first lens element is convex in a paraxial region thereof. Preferably, the second lens element has positive refractive power. Preferably, the image-side surface of the third lens element is concave in a paraxial region thereof. Preferably, the object-side surface of the fourth lens element is convex in a paraxial region thereof, the image-side surface of the fourth lens element is concave in a paraxial region thereof. Preferably, at least one of the second lens element to the sixth lens element includes at least one inflection point in an optical effective area thereof. When an axial distance between the third lens element and the fourth lens element is T34, an axial distance between the fourth lens element and the fifth lens element is T45, an axial distance between the fifth lens element and the sixth lens element is T56, an axial distance between the object-side surface of the first lens element and the image-side surface of the second lens element of the imaging optical lens assembly is Dr1r4, a central thickness of the third lens element is CT3, a focal length of the imaging optical lens assembly is f, and a curvature radius of the image-side surface of the third lens element is R6, the following conditions are preferably satisfied: 0.10< (T34+T45)/T56<1.6; 6.5<Dr1r4/CT3; and 4.4<f/R6.

According to one aspect of the present disclosure, an imaging optical lens assembly includes six lens elements, the six lens elements being, in order from an object side to an image side along an optical path, a first lens element, a second lens element, a third lens element, a fourth lens element, a fifth lens element and a sixth lens element. Each of the sixth lens elements has an object-side surface towards the object side and an image-side surface towards the image side. Preferably, the object-side surface of the first lens element is convex in a paraxial region thereof. Preferably, the object-side surface of the second lens element is convex in a paraxial region thereof. Preferably, the image-side surface of the third lens element is concave in a paraxial region thereof. Preferably, the object-side surface of the fourth lens element is convex in a paraxial region thereof, the image-side surface of the fourth lens element is concave in a paraxial region thereof. Preferably, at least one of the second lens element to the sixth lens element includes at least one inflection point in an optical effective area thereof. When an axial distance between the third lens element and the fourth lens element is T34, an axial distance between the fourth lens element and the fifth lens element is T45, an axial distance between the fifth lens element and the sixth lens element is T56, an axial distance between the object-side surface of the first lens element and the image-side surface of the second lens element of the imaging optical lens assembly is Dr1r4, a central thickness of the third lens element is CT3, a focal length of the imaging optical lens assembly is f, and a curvature radius of the image-side surface of the third lens element is R6, the following conditions are preferably satisfied: 0.10< (T34+T45)/T56<1.6; 6.5<Dr1r4/CT3; and 4.4<f/R6.

According to one aspect of the present disclosure, an imaging optical lens assembly includes six lens elements, the six lens elements being, in order from an object side to an image side along an optical path, a first lens element, a second lens element, a third lens element, a fourth lens element, a fifth lens element and a sixth lens element. Each of the sixth lens elements has an object-side surface towards the object side and an image-side surface towards the image side. Preferably, the object-side surface of the first lens element is convex in a paraxial region thereof. Preferably, the object-side surface of the second lens element is convex in a paraxial region thereof. Preferably, the third lens element has negative refractive power. Preferably, the object-side surface of the fourth lens element is convex in a paraxial region thereof, the image-side surface of the fourth lens element is concave in a paraxial region thereof. Preferably, at least one of the second lens element to the sixth lens element includes at least one inflection point in an optical effective area thereof. When an axial distance between the third lens element and the fourth lens element is T34, an axial distance between the fourth lens element and the fifth lens element is T45, an axial distance between the fifth lens element and the sixth lens element is T56, an axial distance between the object-side surface of the first lens element and the image-side surface of the second lens element of the imaging optical lens assembly is Dr1r4, a central thickness of the third lens element is CT3, and a central thickness of the fourth lens element is CT4, the following conditions are preferably satisfied: 0.10< (T34+T45)/T56<1.6; 11<Dr1r4/CT3<45; and 0.10<CT4/CT3<1.7.

According to one aspect of the present disclosure, an imaging apparatus includes the imaging optical lens assembly of the aforementioned aspect and an image sensor. The image sensor is disposed on an image surface of the imaging optical lens assembly.

According to one aspect of the present disclosure, an electronic device includes the imaging apparatus of the aforementioned aspect.

### BRIEF DESCRIPTION OF THE DRAWINGS

FIG. 1 is a schematic view of an imaging apparatus at the 1st state according to the 1st embodiment of the present disclosure.

FIG. 2A shows spherical aberration curves, astigmatic field curves and a distortion curve of the imaging apparatus at the 1st state according to the 1st embodiment.

FIG. 2B shows spherical aberration curves, astigmatic field curves and a distortion curve of the imaging apparatus at the 2nd state according to the 1st embodiment.

FIG. 3 is a schematic view of an imaging apparatus at the 1st state according to the 2nd embodiment of the present disclosure.

FIG. 4A shows spherical aberration curves, astigmatic field curves and a distortion curve of the imaging apparatus at the 1st state according to the 2nd embodiment.

FIG. 4B shows spherical aberration curves, astigmatic field curves and a distortion curve of the imaging apparatus at the 2nd state according to the 2nd embodiment.

FIG. 5 is a schematic view of an imaging apparatus at the 1st state according to the 3rd embodiment of the present disclosure.

FIG. 6A shows spherical aberration curves, astigmatic field curves and a distortion curve of the imaging apparatus at the 1st state according to the 3rd embodiment.

FIG. 6B shows spherical aberration curves, astigmatic field curves and a distortion curve of the imaging apparatus at the 2nd state according to the 3rd embodiment.

FIG. 7 is a schematic view of an imaging apparatus at the 1st state according to the 4th embodiment of the present disclosure.

FIG. 8A shows spherical aberration curves, astigmatic field curves and a distortion curve of the imaging apparatus at the 1st state according to the 4th embodiment.

FIG. 8B shows spherical aberration curves, astigmatic field curves and a distortion curve of the imaging apparatus at the 2nd state according to the 4th embodiment.

FIG. 9 is a schematic view of an imaging apparatus at the 1st state according to the 5th embodiment of the present disclosure.

FIG. 10A shows spherical aberration curves, astigmatic field curves and a distortion curve of the imaging apparatus at the 1st state according to the 5th embodiment.

FIG. 10B shows spherical aberration curves, astigmatic field curves and a distortion curve of the imaging apparatus at the 2nd state according to the 5th embodiment.

FIG. 11 is a schematic view of an imaging apparatus at the 1st state according to the 6th embodiment of the present disclosure.

FIG. 12A shows spherical aberration curves, astigmatic field curves and a distortion curve of the imaging apparatus at the 1st state according to the 6th embodiment.

FIG. 12B shows spherical aberration curves, astigmatic field curves and a distortion curve of the imaging apparatus at the 2nd state according to the 6th embodiment.

FIG. 13 is a schematic view of the folded light path of the imaging apparatus according to the 1st embodiment of the present disclosure.

FIG. 14 is a schematic view of the imaging apparatus according to the 1st embodiment of the present disclosure with different type of the light path folding element E8.

FIG. 15A is a schematic view of the second lens element according to the 1st embodiment of FIG. 1.

FIG. 15B is a schematic view of the optical effective area of the object-side surface of the second lens element and the parameters according to the 1st embodiment of FIG. 1.

FIG. 16 is a schematic view of the stop and the parameters according to the 1st embodiment of FIG. 1.

FIG. 17 is a schematic view of the folded light path of the imaging apparatus according to the 6th embodiment of the present disclosure.

FIG. 18A is a schematic view of one side of an electronic device according to the 7th embodiment of the present disclosure.

FIG. 18B is a schematic view of another side of the electronic device of FIG. 18A.

FIG. 18C is a system schematic view of the electronic device of FIG. 18A.

FIG. 19 is a schematic view of one side of an electronic device according to the 8th embodiment of the present disclosure.

FIG. 20A is a schematic view of an arrangement of a light path folding element in the imaging optical lens assembly of the present disclosure.

FIG. 20B is a schematic view of another arrangement of the light path folding element in the imaging optical lens assembly of the present disclosure.

FIG. 20C is a schematic view of an arrangement of two light path folding elements in the imaging optical lens assembly of the present disclosure.

### DETAILED DESCRIPTION

The present disclosure provides an imaging optical lens assembly, which includes six lens elements, the six lens elements being, in order from an object side to an image side along an optical path, a first lens element, a second lens element, a third lens element, a fourth lens element, a fifth lens element and a sixth lens element. Each of the sixth lens elements has an object-side surface towards the object side and an image-side surface towards the image side.

The first lens element can have positive refractive power, so that it is favorable for compressing the volume on the object side of the imaging optical lens assembly. The object-side surface of the first lens element is convex in a paraxial region thereof, so that it is favorable for compressing the outer diameter of the object side of the imaging optical lens assembly. Further, when the imaging optical lens assembly can further include a reflective surface which is rotatable relative to the image sensor, it is favorable for enhancing the image compensation ability.

The second lens element can have positive refractive power, so that it is favorable for compressing the volume on the object side of the imaging optical lens assembly. The object-side surface of the second lens element can be convex in a paraxial region thereof, so that it is favorable for compressing the outer diameter of the object side of the imaging optical lens assembly.

The third lens element can have negative refractive power, so that it is favorable for balancing the refractive power on the object side of the imaging optical lens assembly so as to reduce aberrations, such as spherical aberration. The image-side surface of the third lens element can be concave in a paraxial region thereof, so that it is favorable for reducing the surface reflection by adjusting the angle of the incident light into the fourth lens element.

The object-side surface of the fourth lens element is convex in a paraxial region thereof, so that it is favorable for compressing the outer diameter of the image side of the imaging optical lens assembly by adjusting the light traveling direction. The image-side surface of the fourth lens element is concave in a paraxial region thereof, so that it is favorable for correcting aberrations, such as astigmatism, by adjusting the surface shape of the fourth lens element.

The fifth lens element can have positive refractive power, so that it is favorable for compressing the volume on the image side of the imaging optical lens assembly.

At least one of the second lens element to the sixth lens element includes at least one inflection point in an optical effective area thereof. Therefore, the variation of the surface of the lens element can be enhanced, and it is favorable for compressing the size of the lens element and enhancing the image quality. Specifically, at least one of the second lens element to the sixth lens element including at least one inflection point in the optical effective area thereof represents at least one of the object-side surface and the image-side surface of at least one of the second lens element to the sixth lens element including at least one inflection point in the optical effective area thereof. Further, each of at least two of the second lens element to the sixth lens element includes at least one inflection point in the optical effective area thereof.

An optical effective area of at least one surface of at least one of the first lens element to the sixth lens element can be non-circular. Therefore, it is favorable for compressing the volume of the imaging optical lens assembly so as to expand the range of application. Specifically, at least one surface of at least one of the first lens element to the sixth lens element represents at least one of the object-side surface and the image-side surface of at least one of the first lens element to the sixth lens element.

The imaging optical lens assembly can further include a stop, which has an optical effective area being non-circular. Therefore, it is favorable for compressing the volume of the imaging optical lens assembly so as to expand the range of application.

The imaging optical lens assembly can further include at least one reflective surface located between the object-side surface of the first lens element and the object-side surface of the second lens element along the optical axis. Therefore, it is favorable for adjusting the space arrangement so as to reduce the design limitation. Further, the reflective surface can be provided by a prism, so that it is favorable for increasing the assembling yield rate. Further, when the imaging optical lens assembly is applied to the imaging apparatus, the reflective surface can be rotatable relative to the image sensor (such as roll, pitch, or yaw, etc.). Therefore, it is favorable for compensating the relative variation of the location between the image and the image sensor so as to achieve the effects, such as optical image stabilization, etc.

In detail, according to the present disclosure, the reflective surface can be disposed in a light path folding element. Further, the reflective surface can be provided by the prism or the mirror, etc. The surface of the prism or the surface of the mirror can be planar or non-planar, such as spherical surface, aspheric surface or freeform surface, etc., but the present disclosure is not limited thereto.

When an axial distance between the third lens element and the fourth lens element is T34, an axial distance between the fourth lens element and the fifth lens element is T45, and an axial distance between the fifth lens element and the sixth lens element is T56, the following condition is satisfied: 0.10< (T34+T45)/T56<1.6. Therefore, it is favorable for obtaining the balance between the volume arrangement and the image quality by adjusting the lens elements arrangements. Furthermore, the following condition can be satisfied: 0.30< (T34+T45)/T56<1.4. Furthermore, the following condition can be satisfied: 0.47≤(T34+T45)/T56≤1.24.

When an axial distance between the object-side surface of the first lens element and the image-side surface of the second lens element of the imaging optical lens assembly is Dr1r4, and a central thickness of the third lens element is CT3, the following condition is satisfied: 6.5<Dr1r4/CT3 or Dr1r4/CT3<45. Therefore, it is favorable for obtaining the balance between the field of view and the volume arrangement and also favorable for matching the arrangement of the reflective surface by adjusting the arrangement of the lens elements on the object side of the imaging optical lens assembly. Furthermore, the following condition can be satisfied: 9.0<Dr1r4/CT3, 11<Dr1r4/CT3, Dr1r4/CT3<37 or Dr1r4/CT3<30. Furthermore, the following condition can be satisfied: 9.0<Dr1r4/CT3<45. Furthermore, the following condition can be satisfied: 11<Dr1r4/CT3<45. Furthermore, the following condition can be satisfied: 13.80≤Dr1r4/CT3≤24.06.

When a focal length of the imaging optical lens assembly is f, and a curvature radius of the image-side surface of the third lens element is R6, the following condition is satisfied: 4.4<f/R6 or f/R6<8.0. Therefore, it is favorable for adjusting the field of view and correcting aberrations by adjusting the surface shape and the refractive power of the third lens element. Furthermore, the following condition can be satisfied: 4.9<f/R6, f/R6<7.4 or f/R6<6.8. Furthermore, the following condition can be satisfied: 4.9<f/R6<8.0. Furthermore, the following condition can be satisfied: 5.42≤f/R6≤6.25.

When the central thickness of the third lens element is CT3, and a central thickness of the fourth lens element is CT4, the following condition is satisfied: 0.10<CT4/CT3<1.7. Therefore, it is favorable for balancing the volume distribution between the object side and image side of the imaging optical lens assembly by cooperating between the third lens element and the fourth lens element. Furthermore, the following condition can be satisfied: 0.40<CT4/CT3<1.4. Furthermore, the following condition can be satisfied: 0.68≤CT4/CT3≤ 1.16.

When an Abbe number of the second lens element is V2, and an Abbe number of the third lens element is V3, the following condition is satisfied: 1.95<V2/V3<3.50. Therefore, it is favorable for correcting aberrations, such as chromatic aberration, by matching the material of the second lens element and the third lens element.

When the axial distance between the object-side surface of the first lens element and the image-side surface of the second lens element of the imaging optical lens assembly is Dr1r4, and an axial distance between the object-side surface of the third lens element and the image-side surface of the sixth lens element of the imaging optical lens assembly is Dr5r12, the following condition is satisfied: 1.6<Dr1r4/Dr5r12<2.3. Therefore, it is favorable for obtaining the balance between the field of view and the volume arrangement by adjusting the arrangement of the lens elements of the imaging optical lens assembly.

When a curvature radius of the object-side surface of the fourth lens element is R7, and a focal length of the fourth lens element is f4, the following condition is satisfied: 0<R7/|f4|<0.55. Therefore, it is favorable for correcting aberrations by adjusting the surface shape and refractive power of the fourth lens element. Furthermore, the following condition can be satisfied: 0<R7/|f4|<0.40.

When a curvature radius of the object-side surface of the third lens element is R5, and the focal length of the imaging optical lens assembly is f, the following condition is satisfied: |f/R5|<0.60. Therefore, it is favorable for correcting aberrations by adjusting the surface shape and refractive power of the third lens element. Furthermore, the following condition can be satisfied: |f/R5|<0.45.

When an f-number of the imaging optical lens assembly is Fno, the following condition is satisfied: 2.0<Fno<3.3. Therefore, it is favorable for balancing the depth of field and the illumination.

When a maximum distance between an optical effective area of the object-side surface of the second lens element and an optical axis is Y21, and a maximum image height of the imaging optical lens assembly is ImgH (which can be half of a diagonal length of an effective photosensitive area of the image sensor), the following condition is satisfied: 0.60<Y21/ImgH<1.0. Therefore, it is favorable for obtaining the balance between the compression of the outer diameter of the lens element and the enlargement of the image surface.

When the focal length of the imaging optical lens assembly is f, and a curvature radius of the image-side surface of the fourth lens element is R8, the following condition is satisfied: 1.1<f/R8<4.5. Therefore, it is favorable for adjusting the field of view in a proper range by adjusting the surface shape and refractive power of the fourth lens element. Furthermore, the following condition can be satisfied: 1.4<f/R8<4.0.

When a focal length of the second lens element is f2, and a curvature radius of the object-side surface of the second lens element is R3, the following condition is satisfied: 1.3<f2/R3<3.0. Therefore, it is favorable for compressing the volume of the object side of the imaging optical lens assembly by adjusting the surface shape and refractive power of the second lens element.

When the focal length of the imaging optical lens assembly is f, and a focal length of the sixth lens element is f6, the following condition is satisfied: |f/f6|<1.1. Therefore, it is favorable for correcting aberrations by adjusting the refractive power of the sixth lens element.

When a curvature radius of the object-side surface of the third lens element is R5, and the curvature radius of the image-side surface of the third lens element is R6, the following condition is satisfied: |R6/R5|<0.16. Therefore, it is favorable for compressing the outer diameter of the lens element and correcting aberrations by adjusting the surface shape of the third lens element. Furthermore, the following condition can be satisfied: |R6/R5|<0.12.

When a curvature radius of the object-side surface of the fourth lens element is R7, and a curvature radius of the image-side surface of the fourth lens element is R8, the following condition is satisfied: 0.85<R8/R7<3.0. Therefore, it is favorable for compressing the outer diameter of the image side of the imaging optical lens assembly by adjusting the light traveling direction.

When half of a maximum field of view of the imaging optical lens assembly is HFOV, the following condition is satisfied: 5.0 degrees<HFOV<20.0 degrees. Therefore, it is favorable for adjusting the field of view so as to adapt application. Furthermore, the following condition can be satisfied: 8.0 degrees<HFOV<16.0 degrees.

When the maximum distance between the optical effective area of the object-side surface of the second lens element and the optical axis is Y21, and a maximum distance between an optical effective area of the image-side surface of the sixth lens element and the optical axis is Y62, the following condition is satisfied: 1.1<Y21/Y62<1.5. Therefore, it is favorable for compressing the outer diameter of the lens elements by adjusting the light traveling direction.

When a focal length of the first lens element is f1, and a focal length of the third lens element is f3, the following condition is satisfied: −16<f1/f3<−5.0. Therefore, it is favorable for correcting aberrations by adjusting the arrangement of the refractive power on the object side of the imaging optical lens assembly.

When a focal length of the fifth lens element is f5, and a central thickness of the fifth lens element is CT5, the following condition is satisfied: 6.0<f5/CT5<90. Therefore, it is favorable for compressing the volume of the image side of the imaging optical lens assembly by adjusting the surface shape and refractive power of the fifth lens element. Furthermore, the following condition can be satisfied: 9.0<f5/CT5<75. Furthermore, the following condition can be satisfied: 11<f5/CT5<60.

When the focal length of the third lens element is f3, and the focal length of the fifth lens element is f5, the following condition is satisfied: −15<f5/f3<−1.2. Therefore, it is favorable for correcting aberrations by adjusting the arrangement of refractive power of the imaging optical lens assembly. Furthermore, the following condition can be satisfied: −12<f5/f3<−1.6. Furthermore, the following condition can be satisfied: −10<f5/f3<−2.0.

Each of the aforementioned features of the imaging optical lens assembly can be utilized in various combinations for achieving the corresponding effects.

According to the imaging optical lens assembly of the present disclosure, the lens elements thereof can be made of glass or plastic materials. When the lens elements are made of glass materials, the distribution of the refractive power of the imaging optical lens assembly may be more flexible to design. The glass lens element can either be made by grinding or molding. When the lens elements are made of plastic materials, manufacturing costs can be effectively reduced. Furthermore, surfaces of each lens element can be arranged to be spherical or aspheric (ASP). Spherical lens elements are simple in manufacture. Aspheric lens elements have more controllable variables for eliminating aberrations thereof, and further decreasing the required amount of lens elements in the imaging optical lens assembly, and the total track length of the imaging optical lens assembly can therefore also be reduced. The aspheric surfaces may be formed by a plastic injection molding method, a glass molding method or other manufacturing methods.

According to the imaging optical lens assembly of the present disclosure, additives which generate light absorption and interference effects can be selectively added into any one (or more) material of the lens elements so as to change the transmittance of the lens element in a particular wavelength range. Therefore, the stray light and chromatic aberration can be reduced. For example, the additives can have the filter ability for light in a wavelength range of 600 nm-800 nm in the imaging optical lens assembly so as to reduce extra red light or infrared light, or the additives can have the filter ability for light in a wavelength range of 350 nm-450 nm in the imaging optical lens assembly so as to reduce blue light or ultraviolet light. Therefore, additives can prevent the image from interfering by light in a particular wavelength range. Furthermore, the additives can be homogeneously mixed with the plastic material, and the lens elements can be made by the injection molding method. Moreover, the additives can be coated on the lens surfaces to provide the aforementioned effects.

According to the imaging optical lens assembly of the present disclosure, when a surface of the lens element is aspheric, it indicates that entire optical effective region of the surface of the lens element or a part thereof is aspheric.

According to the imaging optical lens assembly of the present disclosure, when the lens elements have surfaces being convex and the convex surface position is not defined, it indicates that the aforementioned surfaces of the lens elements can be convex in the paraxial region thereof. When the lens elements have surfaces being concave and the concave surface position is not been defined, it indicates that the aforementioned surfaces of the lens elements can be concave in the paraxial region thereof. In the imaging optical lens assembly of the present disclosure, if the lens element has positive refractive power or negative refractive power, or the focal length of the lens element, all can be referred to the refractive power, or the focal length, in the paraxial region of the lens element.

According to the imaging optical lens assembly of the present disclosure, a critical point is a non-axial point of the lens surface where its tangent is perpendicular to the optical axis; an inflection point is a point on a lens surface with a curvature changing from positive to negative or from negative to positive.

According to the imaging optical lens assembly of the present disclosure, the image surface thereof, based on the corresponding image sensor, can be flat or curved. In particular, the image surface can be a concave curved surface facing towards the object side. Furthermore, the imaging optical lens assembly of the present disclosure can selectively include at least one image correcting element (such as a field flattener) inserted between the lens element closest to the image surface and the image surface, thus the effect of correcting image aberrations (such as field curvature) can be achieved. The optical properties of the aforementioned image correcting element, such as curvature, thickness, refractive index, position, surface shape (convex or concave, spherical or aspheric, diffraction surface and Fresnel surface, etc.) can be adjusted corresponding to the demands of the imaging apparatus. Generally, a preferred configuration of the image correcting element is to dispose a thin plano-concave element having a concave surface toward the object side on the position closed to the image surface.

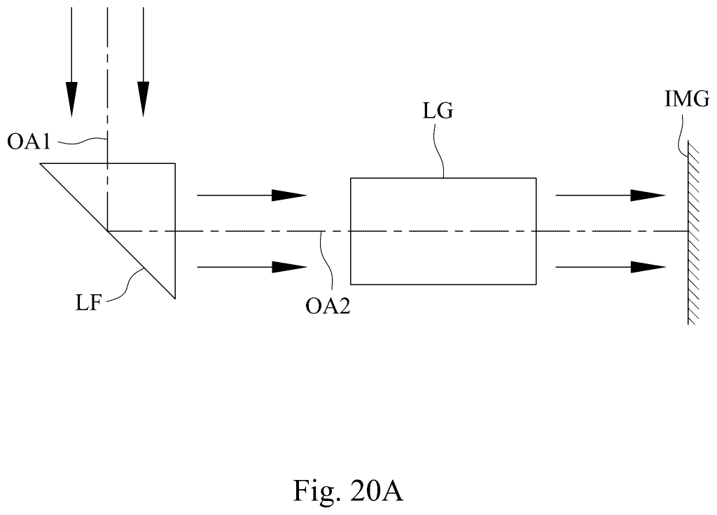

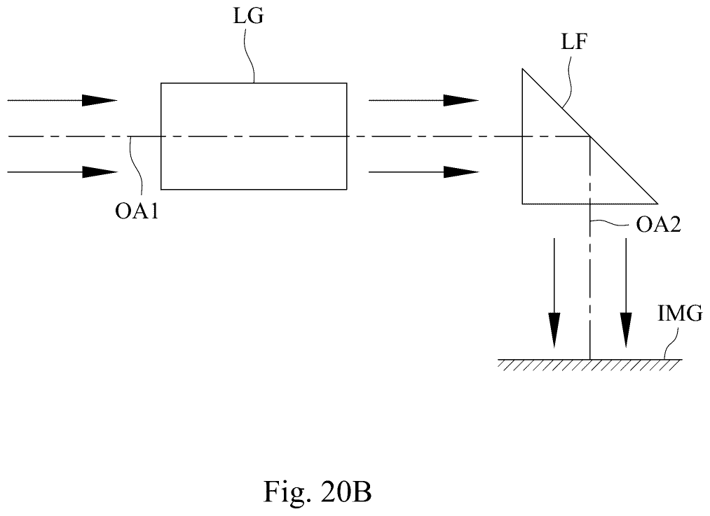

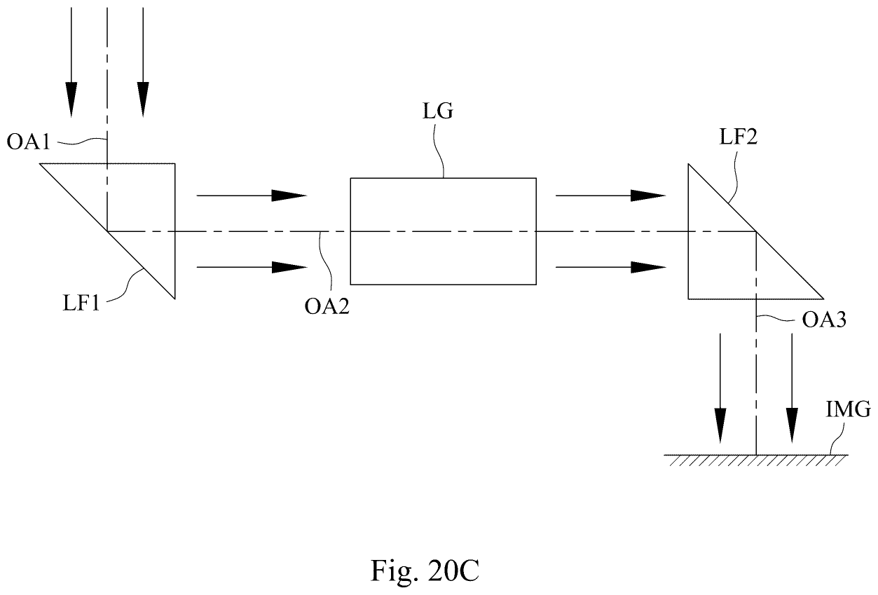

According to the imaging optical lens assembly of the present disclosure, at least one element with light path folding function can be selectively disposed between the imaged object and the image surface, such as a prism or a mirror, etc. And the surface shape of the prism or mirror can be planar, spherical, aspheric or freeform surface. Therefore, it is favorable for providing high flexible space arrangement of the imaging optical lens assembly, so that the compactness of the electronic device would not be restricted by the optical total track length of the imaging optical lens assembly. FIG. 20A is a schematic view of an arrangement of a light path folding element LF in the imaging optical lens assembly of the present disclosure. FIG. 20B is a schematic view of another arrangement of the light path folding element LF in the imaging optical lens assembly of the present disclosure. As shown in FIGS. 20A and 20B, the imaging optical lens assembly includes, in order from an imaged object (not shown in drawings) to an image surface IMG, a first optical axis OA1, the light path folding element LF and a second optical axis OA2, wherein the light path folding element LF can be disposed between the imaged object and a lens group LG of the imaging optical lens assembly as shown in FIG. 20A, or can be disposed between the lens group LG of the imaging optical lens assembly and the image surface IMG as shown in FIG. 20B. Moreover, FIG. 20C is a schematic view of an arrangement of two light path folding elements LF1, LF2 in the imaging optical lens assembly of the present disclosure. As shown in FIG. 20C, the imaging optical lens assembly includes, in order from an imaged object (not shown in drawings) to an image surface IMG, a first optical axis OA1, the light path folding element LF1, a second optical axis OA2, the light path folding element LF2 and a third optical axis OA3, wherein the light path folding element LF1 is disposed between the imaged object and a lens group LG of the imaging optical lens assembly, and the light path folding element LF2 is disposed between the lens group LG of the imaging optical lens assembly and the image surface IMG. The imaging optical lens assembly can also be selectively disposed with three or more light path folding element, the type, amount and location of the light path folding element will not be limited to the present disclosure.

Furthermore, according to the imaging optical lens assembly of the present disclosure, the imaging optical lens assembly can include at least one stop, such as an aperture stop, a glare stop or a field stop, for eliminating stray light and thereby improving image resolution thereof.

According to the imaging optical lens assembly of the present disclosure, the aperture stop can be configured as a front stop or a middle stop, wherein the front stop indicates that the aperture stop is disposed between an object and the first lens element, and the middle stop indicates that the aperture stop is disposed between the first lens element and the image surface. When the aperture stop is a front stop, a longer distance between an exit pupil of the imaging optical lens assembly and the image surface can be obtained, and thereby obtains a telecentric effect and improves the image-sensing efficiency of the image sensor, such as CCD or CMOS. The middle stop is favorable for enlarging the field of view of the imaging optical lens assembly and thereby provides a wider field of view for the same.

According to the imaging optical lens assembly of the present disclosure, an aperture control unit can be properly configured. The aperture control unit can be a mechanical element or a light controlling element, and the dimension and the shape of the aperture control unit can be electrically controlled. The mechanical element can include a moveable component such a blade group or a shielding plate. The light controlling element can include a screen component such as a light filter, an electrochromic material, a liquid crystal layer or the like. The amount of incoming light or the exposure time of the image can be controlled by the aperture control unit to enhance the image moderation ability. In addition, the aperture control unit can be the aperture stop of the imaging optical lens assembly according to the present disclosure, so as to moderate the image quality by changing f-number such as changing the depth of field or the exposure speed.

According to the imaging optical lens assembly of the present disclosure, one or more optical elements can be properly configured for limiting the form of light passing through the imaging optical lens assembly. Each optical element can be, but not limited to, a filter, a polarizer, etc. Each optical element can be, but not limited to, a single-piece element, a composite component, a thin film, etc. The optical element can be located at the object side or the image side of the imaging optical lens assembly or between any two adjacent lens elements so as to allow light in a specific form to pass through, thereby meeting application requirements.

The imaging optical lens assembly according to the present disclosure can include at least one optical lens element, an optical element or a carrier, which has at least one surface with a low reflection layer, wherein the low reflection layer is favorable for effectively reducing the stray light formed by the reflection of light on the interface. The low reflection layer can be disposed on the non-optically effective area of the object-side surface or the image-side surface of the optical lens element, or can be disposed on the connecting surface between the object-side surface or the image-side surface; wherein the optical element can be a light blocking element, an annular spacer element, a barrel element, a cover glass, a blue glass, a filter or a color filter, a light path folding element, a prism or a mirror, etc.; wherein the carrier can be a lens group base, a micro lens disposed on the image sensor, the peripheral of the image sensor substrate or a glass sheet for protecting the image sensor, etc.

According to the imaging optical lens assembly of the present disclosure, the object side and the image side are defined according to the direction of the optical axis, and the axial value is calculated along the optical axis.

According to the imaging optical lens assembly of the present disclosure, the imaging optical lens assembly of the present disclosure can be applied to 3D (three-dimensional) image capturing applications, in products such as digital cameras, mobile devices, digital tablets, smart TVs, surveillance systems, motion sensing input devices, driving recording systems, rearview camera systems, wearable devices, unmanned aerial vehicles, and other electronic imaging products.

According to the present disclosure, an imaging apparatus including the aforementioned imaging optical lens assembly and an image sensor is provided, wherein the image sensor is disposed on the image surface of the imaging optical lens assembly. By adjusting the arrangement of the lens elements in the imaging optical lens assembly, it is favorable for balancing the volume arrangement, the image quality and the field of view, and also favorable for the arrangement of the reflective surface. Moreover, the imaging apparatus can further include a barrel member, a holder member or a combination thereof.

According to the present disclosure, at least one of the six lens elements can be movable relative to the image sensor along the optical axis so as to achieve the effects such as zooming or focusing, etc. Therefore, it is favorable for expanding the range of application of the imaging optical lens assembly. In the imaging apparatus, at least two, three, four or fifth of the six lens elements can be movable relative to the image sensor along the optical axis. Further, the lens elements can also be movable for focusing corresponding to the variation of the object distance

According to the present disclosure, an electronic device including the aforementioned imaging apparatus is provided. Therefore, the image quality can be increased. Moreover, the electronic device can further include a control unit, a display, a storage unit, a random-access memory unit (RAM) or a combination thereof.

According to the above description of the present disclosure, the following specific embodiments are provided for further explanation.

### 1st Embodiment

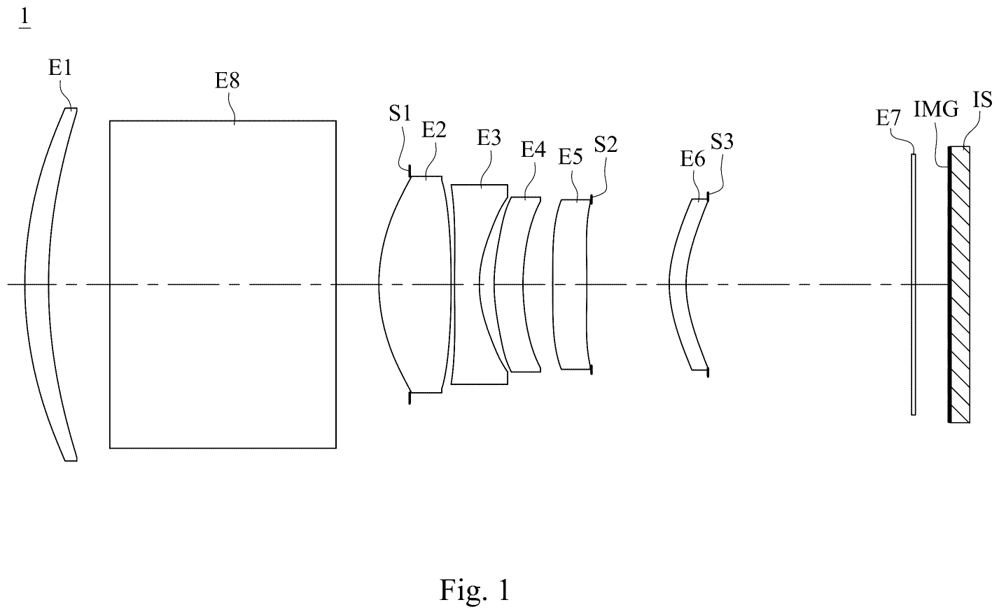

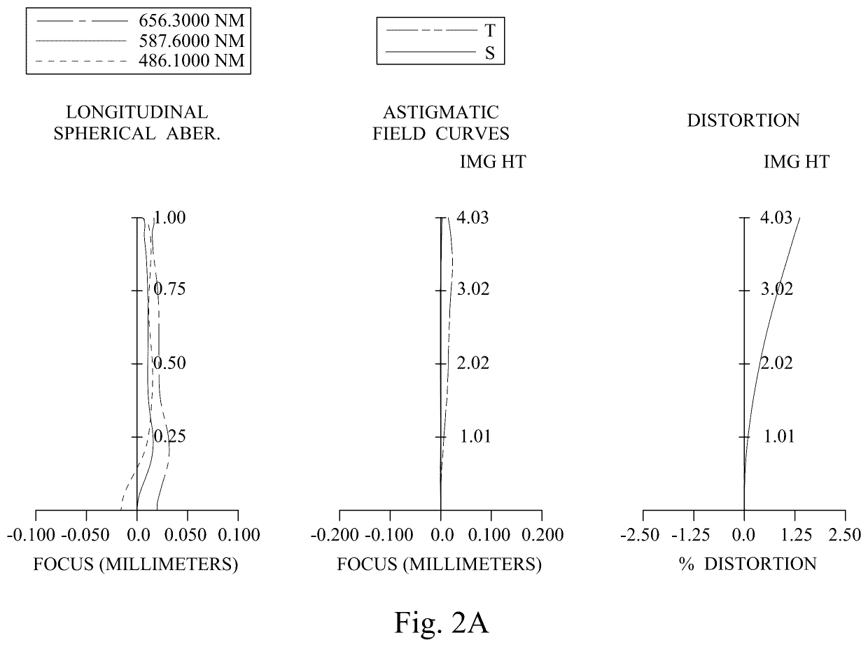

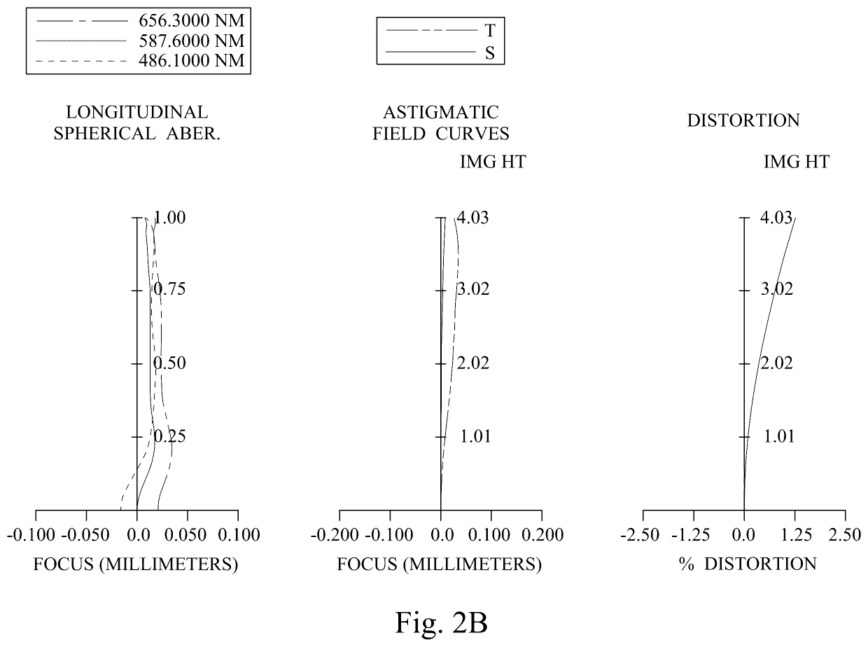

FIG. 1 is a schematic view of an imaging apparatus 1 at the 1st state according to the 1st embodiment of the present disclosure. FIG. 2A shows spherical aberration curves, astigmatic field curves and a distortion curve of the imaging apparatus 1 at the 1st state according to the 1st embodiment. FIG. 2B shows spherical aberration curves, astigmatic field curves and a distortion curve of the imaging apparatus 1 at the 2nd state according to the 1st embodiment. In FIG. 1, the imaging apparatus 1 includes an imaging optical lens assembly (its reference numeral is omitted) and an image sensor IS. The imaging optical lens assembly includes, in order from an object side to an image side along an optical path, a first lens element E1, a light path folding element E8, a stop S1, a second lens element E2, a third lens element E3, a fourth lens element E4, a fifth lens element E5, a stop S2, a sixth lens element E6, a stop S3, a filter E7 and an image surface IMG, wherein the image sensor IS is disposed on the image surface IMG of the imaging optical lens assembly. The imaging optical lens assembly includes six lens elements (E1, E2, E3, E4, E5, E6) without additional one or more lens elements inserted between the first lens element E1 and the sixth lens element E6.

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric.

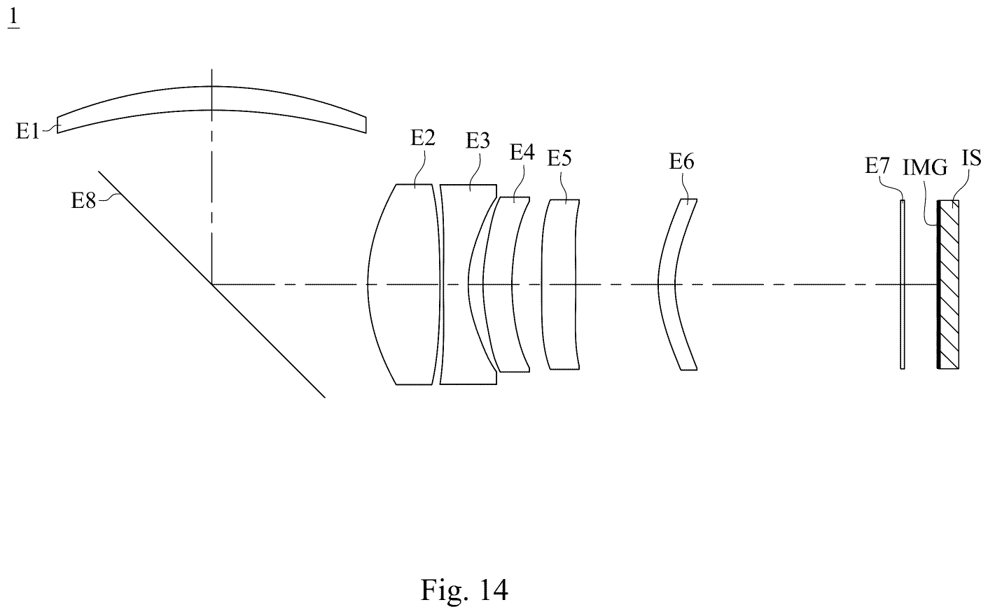

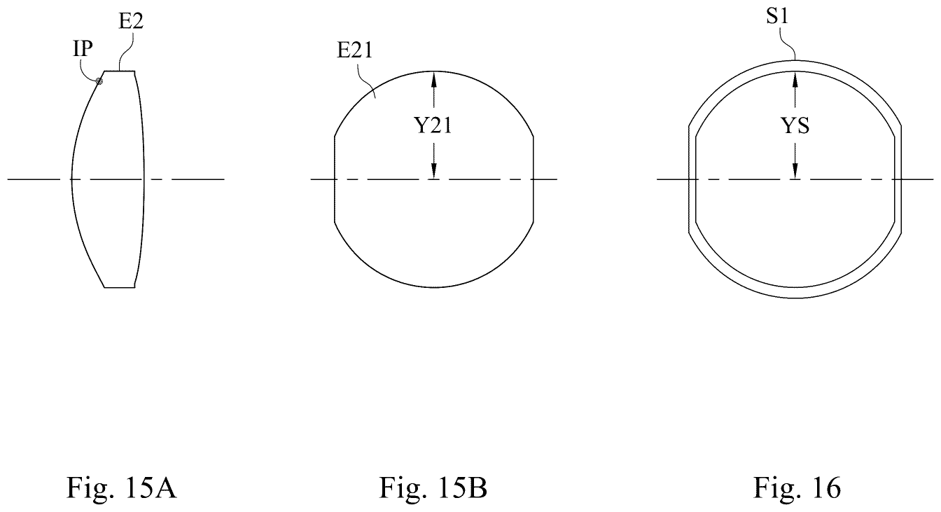

The second lens element E2 with positive refractive power has an object-side surface being convex in a paraxial region thereof and an image-side surface being convex in a paraxial region thereof. The second lens element E2 is made of glass material, and has the object-side surface and the image-side surface being both aspheric. Further, FIG. 15A is a schematic view of the second lens element E2 according to the 1st embodiment of FIG. 1. In FIG. 15A, the second lens element E2 includes at least one inflection point IP in an optical effective area thereof; specifically, at both of the 1st state and the 2nd state, the object-side surface of the second lens element E2 includes one inflection point IP in the optical effective area thereof. In each of the embodiments in the present disclosure, only the inflection points in the optical effective area of part of the lens elements at some states are taken as examples, and will not be limited thereto. In the present disclosure, each state of each embodiment, each of the object-side surface and the image-side surface of each lens element can include at least one inflection point in the optical effective area.

The third lens element E3 with negative refractive power has an object-side surface being convex in a paraxial region thereof and an image-side surface being concave in a paraxial region thereof. The third lens element E3 is made of plastic material, and has the object-side surface and the image-side surface being both aspheric. Furthermore, the third lens element E3 includes at least one inflection point (its reference numeral is omitted) in an optical effective area thereof.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Furthermore, the fourth lens element E4 includes at least one inflection point (its reference numeral is omitted) in an optical effective area thereof.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Furthermore, the fifth lens element E5 includes at least one inflection point (its reference numeral is omitted) in an optical effective area thereof.

The sixth lens element E6 with positive refractive power has an object-side surface being convex in a paraxial region thereof and an image-side surface being concave in a paraxial region thereof. The sixth lens element E6 is made of plastic material, and has the object-side surface and the image-side surface being both aspheric.

The light path folding element E8 is disposed between the first lens element E1 and the second lens element E2 along the optical axis, which is a prism, and is made of glass material. The light path folding element E8 has a reflective surface, and is rotatable relative to the image sensor IS.

The filter E7 is made of glass material, which is located between the sixth lens element E6 and the image surface IMG in order, and will not affect the focal length of the imaging optical lens assembly.

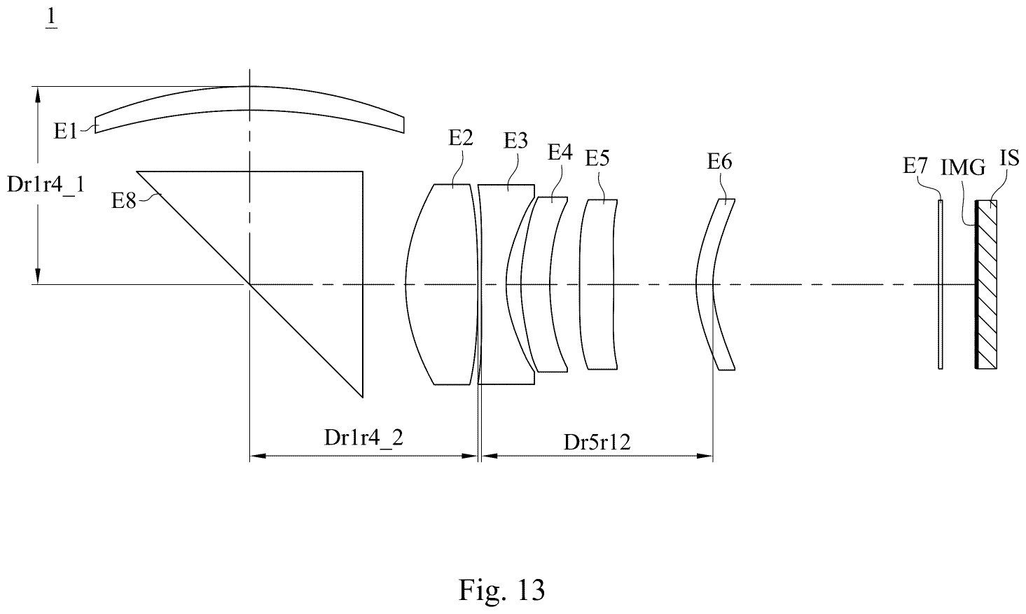

The imaging optical lens assembly can include at least one reflective surface located between the object-side surface of the first lens element E1 and the object-side surface of the second lens element E2 along the optical axis. According to the 1st embodiment, the reflective surface is disposed on the light path folding element E8. In the present disclosure, the kind and the arrangement of the reflective surface and the light path folding element E8 will not be limited to the state as shown. For example, the reflective surface can be provided by the prism or the mirror, etc., and the surface of the prism or the surface of the mirror can be planar or non-planar, such as spherical surface, aspheric surface or freeform surface, etc., but the present disclosure is not limited thereto. FIG. 13 is a schematic view of the folded light path of the imaging apparatus 1 according to the 1st embodiment of the present disclosure. In FIG. 13, the light path is folded by the reflective surface of the light path folding element E8, which can be compared to the state as shown in FIG. 1, which is not be folded. In the present disclosure, the folded light path can be similar to the form as shown in FIG. 13, and will not be described again. Furthermore, FIG. 14 is a schematic view of the imaging apparatus 1 according to the 1st embodiment of the present disclosure with different type of the light path folding element E8. In FIG. 14, the light path folding element E8 can be arranged as the mirror which can fold the light path.

The reflective surface can be rotatable relative to the image sensor IS (such as roll, pitch, or yaw, etc.), which can compensate the relative variation of the location between the image and the image sensor IS, wherein the rotating method can be adjusted on demand. For example, the first lens element E1 can be moved with the light path folding element E8 so as to rotate relative to the image sensor IS, or the light path folding element E8 can be the only one which is rotated relative to the image sensor IS, and the present disclosure will not be limited thereto.

The optical effective area of each surface of each lens element can be non-circular at each state. FIG. 15B is a schematic view of the optical effective area E21 of the object-side surface of the second lens element E2 and the parameters according to the 1st embodiment of FIG. 1. In FIG. 15B, according to the 1st embodiment, the optical effective area E21 of the object-side surface of the second lens element E2 is non-circular at both of the 1st state and the 2nd state. The non-circular can be similar to the shape shown in FIG. 15B, but can be arranged in others non-circular types on demand, which will not be limited thereto.

The optical effective area of each stop can be non-circular at each state. FIG. 16 is a schematic view of the stop S1 and the parameters according to the 1st embodiment of FIG. 1. In FIG. 16, according to the 1st embodiment, the optical effective area of the stop S1 is non-circular at both of the 1st state and the 2nd state, and a maximum distance between the optical effective area of the stop S1 and the optical axis is YS. The non-circular can be similar to the shape shown in FIG. 16, but can be arranged in others non-circular types on demand, which will not be limited thereto.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,
X is the displacement in parallel with the optical axis from the intersection point of the aspheric surface and the optical axis to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient.

The detailed optical data of the 1st embodiment are shown in Table 1A and the aspheric surface data are shown in Table 1B below.

TABLE 1A
1st Embodiment

| Surface | | | | | | | Abbe | Focal |
|---|---|---|---|---|---|---|---|---|
| # | | Curvature Radius | | Thickness | Material | Index | # | Length |
| 0 | Object | Plano | | D0 | | | | |
| 1 | Lens 1 | 11.2737 | ASP | 0.692 | Plastic | 1.545 | 56.1 | 83.05 |
| 2 | | 14.6884 | ASP | 1.789 | | | | |
| 3 | Prism | Plano | | 6.600 | Glass | 1.785 | 25.7 | — |
| 4 | | Plano | | D4 | | | | |
| 5 | Stop | Plano | | −0.897 | | | | |
| 6 | Lens 2 | 5.0866 | ASP | 2.108 | Glass | 1.589 | 61.2 | 7.83 |
| 7 | | −41.8803 | ASP | 0.100 | | | | |
| 8 | Lens 3 | 58.6513 | ASP | 0.724 | Plastic | 1.587 | 28.3 | −6.37 |
| 9 | | 3.5001 | ASP | 0.431 | | | | |
| 10 | Lens 4 | 5.2318 | ASP | 0.840 | Plastic | 1.615 | 25.4 | 44.65 |
| 11 | | 6.0691 | ASP | 0.869 | | | | |
| 12 | Lens 5 | 131.5208 | ASP | 0.994 | Plastic | 1.705 | 14.0 | 51.44 |
| 13 | | −49.8922 | ASP | 0.140 | | | | |
| 14 | Stop | Plano | | 2.266 | | | | |
| 15 | Lens 6 | 3.4108 | ASP | 0.491 | Plastic | 1.544 | 56.0 | 273.35 |
| 16 | | 3.3138 | ASP | 0.642 | | | | |

| | | | | | | | |
|---|---|---|---|---|---|---|---|
| 17 | Stop | Plano | D17 | | | | |
| 18 | Filter | Plano | 0.110 | Glass | 1.517 | 64.2 | — |
| 19 | | Plano | 1.000 | | | | |
| 20 | Image | Plano | — | | | | |

Reference wavelength is 587.6 nm (d-line).
Prism has a reflective surface.
Maximum distance between the optical effective area of Surface 5 (stop S1) and the optical axis is 3.155 mm.
Maximum distance between the optical effective area of Surface 14 (stop S2) and the optical axis is 2.366 mm.
Maximum distance between the optical effective area of Surface 17 (stop S3) and the optical axis is 2.440 mm.

TABLE 1B
Aspheric Coefficients

| Surface # | 1 | 2 | 6 | 7 |
|---|---|---|---|---|
| k= | −1.11057E−01 | 4.36310E−01 | 1.03388E−01 | 0.00000E+00 |
| A4= | −1.4333890E−04 | −2.1666880E−04 | −1.5166729E−03 | −8.1656081E−03 |
| A6= | 1.4815887E−05 | 1.9826262E−05 | 1.0061815E−04 | 3.3774530E−03 |
| A8= | −1.8766281E−06 | −2.3728780E−06 | −1.7653598E−05 | −7.6340010E−04 |
| A10= | 1.6962849E−07 | 2.1922190E−07 | 2.8670288E−06 | 7.5592277E−05 |
| A12= | −9.2369355E−09 | −1.2678966E−08 | −4.0848410E−07 | 2.3096154E−06 |
| A14= | 2.8113751E−10 | 4.1544764E−10 | 3.1198206E−08 | −1.4965538E−06 |
| A16= | −4.4839509E−12 | −7.2063352E−12 | −1.2993208E−09 | 1.6824332E−07 |
| A18= | 2.8174136E−14 | 5.0590833E−14 | | −8.5656121E−09 |
| A20= | | | | 1.7130468E−10 |

| Surface # | 8 | 9 | 10 | 11 |
|---|---|---|---|---|
| k= | 0.00000E+00 | 5.63678E−02 | −4.85335E−01 | −5.92002E−03 |
| A4= | −2.6511927E−03 | 6.5017920E−03 | −2.3038797E−03 | −3.1880655E−03 |
| A6= | −1.3779201E−03 | −1.1959086E−02 | −5.7993624E−03 | −2.1452885E−03 |
| A8= | 1.3861338E−03 | 5.2369666E−03 | 2.2254094E−03 | 1.7537373E−03 |
| A10= | −6.0074903E−04 | −1.4077299E−03 | −1.2427664E−04 | −4.8299524E−04 |
| A12= | 1.4359972E−04 | 1.9462176E−04 | −1.6039651E−04 | 6.3414042E−05 |
| A14= | −2.0470176E−05 | −1.7030300E−06 | 6.1379465E−05 | 2.9489160E−07 |
| A16= | 1.7476057E−06 | −3.2426290E−06 | −1.0333266E−05 | −1.2748340E−06 |
| A18= | −8.2743501E−08 | 4.0909186E−07 | 8.6778574E−07 | 1.4858874E−07 |
| A20= | 1.6735646E−09 | −1.6942114E−08 | −2.9884458E−08 | −5.4523090E−09 |
| Surface # | 12 | 13 | 15 | 16 |
| k= | 0.00000E+00 | 0.00000E+00 | −2.82267E−02 | 2.43298E−03 |
| A4= | 5.3409796E−03 | 2.9151787E−03 | −1.3728576E−02 | −1.5071549E−02 |
| A6= | 1.5060831 E−04 | 5.8898223E−04 | 5.3945907E−04 | 5.9792072E−04 |
| A8= | 1.9288087E−04 | −3.9266289E−06 | 3.8357521E−05 | 1.9510353E−05 |
| A10= | −1.0956278E−04 | −3.7715832E−05 | −2.2250075E−05 | −1.4075568E−05 |
| A12= | 2.4593946E−05 | 1.0548224E−05 | 5.1841495E−06 | 1.8830481E−06 |
| A14= | −2.7568108E−06 | −1.2003589E−06 | −7.6066333E−07 | −1.0577013E−07 |
| A16= | 1.4612994E−07 | 5.8326313E−08 | 6.5728449E−08 | 9.4439029E−10 |
| A18= | −2.2081220E−09 | | −2.5389903E−09 | |

In Table 1A, the curvature radius, the thickness and the focal length are shown in millimeters (mm). Surface numbers 0-20 represent the surfaces sequentially arranged from the object side to the image side along the optical axis. Index is measured according the reference wavelength. In Table 1B, k represents the conic coefficient of the equation of the aspheric surface profiles. A4-A20 represent the aspheric coefficients ranging from the 4th order to the 20th order. The tables presented below for each embodiment correspond to schematic parameter and aberration curves of each embodiment, and term definitions of the tables are the same as those in Table 1A and Table 1B of the 1st embodiment. Therefore, an explanation in this regard will not be provided again.

Please refer to FIG. 1, FIG. 2A and FIG. 2B, the values of f, Fno, HFOV, D0, D4 and D17 at the 1st state (as shown in FIG. 1 and FIG. 2A) and at the 2nd state (as shown in FIG. 2B) are shown in Table 1C. A focal length of the imaging optical lens assembly is f, an f-number of the imaging optical lens assembly is Fno, half of a maximum field of view of the imaging optical lens assembly is HFOV, and the definitions of D0, D4 and D17 can refer to Table 1A, wherein D0 is the central thickness of surface 0, D4 is the central thickness of surface 4, D17 is the central thickness of surface 17. In the present disclosure, each embodiment can be at other states, or can be only the 1st state or the 2nd state, and will not be limited thereto. For example, at other states, the values of D0, D4 and D17 can between the 1st state and the 2nd state, or can be greater than or smaller than the 1st state or the 2nd state.

TABLE 1C
1st Embodiment

| State | 1st | 2nd |
|---|---|---|
| f (mm) | 19.12 | 19.03 |
| Fno | 2.69 | 2.79 |
| HFOV (deg.) | 11.7 | 11.4 |
| D0 | Infinity | 800.000 |
| D4 | 2.147 | 1.655 |
| D17 | 5.941 | 6.433 |

According to the imaging optical lens assembly of the 1st embodiment, the second lens element E2 to the sixth lens element E6 can be moved along the optical axis relative to the image sensor IS so as to focus corresponding to the variation of the object distance, but will not be limited thereto. For example, any one, any two, any three . . . or all lens elements of the six lens element can be moved along the optical axis relative to the image sensor IS on demand.

According to the imaging optical lens assembly, when an Abbe number of the second lens element E2 is V2, and an Abbe number of the third lens element E3 is V3, the following condition is satisfied at the 1st state: V2/V3=2.16; the following condition is satisfied at the 2nd state: V2/V3=2.16.

According to the imaging optical lens assembly, when an axial distance between the third lens element E3 and the fourth lens element E4 is T34, an axial distance between the fourth lens element E4 and the fifth lens element E5 is T45, and an axial distance between the fifth lens element E5 and the sixth lens element E6 is T56, the following condition is satisfied at the 1st state: (T34+T45)/T56=0.54; the following condition is satisfied at the 2nd state: (T34+T45)/T56=0.54. According to the 1st embodiment, an axial distance between two adjacent lens elements is the distance between the two adjacent surfaces of the two adjacent lens elements on the optical axis.

According to the imaging optical lens assembly, when a central thickness of the third lens element E3 is CT3, and a central thickness of the fourth lens element E4 is CT4, the following condition is satisfied at the 1st state: CT4/CT3=1.16; the following condition is satisfied at the 2nd state: CT4/CT3=1.16.

According to the imaging optical lens assembly, when an axial distance between the object-side surface of the first lens element E1 and the image-side surface of the second lens element E2 of the imaging optical lens assembly is Dr1r4, and the central thickness of the third lens element E3 is CT3, the following condition is satisfied at the 1st state: Dr1r4/CT3=17.18; the following condition is satisfied at the 2nd state: Dr1r4/CT3=16.50. Furthermore, in FIG. 13, corresponding to the folded light path, Dr1r4 is the sum of the sectional distance Dr1r4_1 and the sectional distance Dr1r4_2.

According to the imaging optical lens assembly, when the axial distance between the object-side surface of the first lens element E1 and the image-side surface of the second lens element E2 of the imaging optical lens assembly is Dr1r4, and an axial distance between the object-side surface of the third lens element E3 and the image-side surface of the sixth lens element E6 of the imaging optical lens assembly is Dr5r12 (labelled in FIG. 13), the following condition is satisfied at the 1st state: Dr1r4/Dr5r12=1.84; the following condition is satisfied at the 2nd state: Dr1r4/Dr5r12=1.77.

According to the imaging optical lens assembly, when a curvature radius of the object-side surface of the third lens element E3 is R5, and a curvature radius of the image-side surface of the third lens element E3 is R6, the following condition is satisfied at the 1st state: |R6/R5|=0.06; the following condition is satisfied at the 2nd state: |R6/R5|=0.06.

According to the imaging optical lens assembly, when a curvature radius of the object-side surface of the fourth lens element E4 is R7, and a focal length of the fourth lens element E4 is f4, the following condition is satisfied at the 1st state: R7/|f4|=0.12; the following condition is satisfied at the 2nd state: R7/|f4|=0.12.

According to the imaging optical lens assembly, when the curvature radius of the object-side surface of the fourth lens element E4 is R7, and a curvature radius of the image-side surface of the fourth lens element E4 is R8, the following condition is satisfied at the 1st state: R8/R7=1.16; the following condition is satisfied at the 2nd state: R8/R7=1.16.

According to the imaging optical lens assembly, when the focal length of the imaging optical lens assembly is f, and a focal length of the sixth lens element E6 is f6, the following condition is satisfied at the 1st state: |f/f6|=0.07; the following condition is satisfied at the 2nd state: |f/f6|=0.07.

According to the imaging optical lens assembly, when the focal length of the imaging optical lens assembly is f, and the curvature radius of the object-side surface of the third lens element E3 is R5, the following condition is satisfied at the 1st state: |f/R5|=0.33; the following condition is satisfied at the 2nd state: |f/R5|=0.32.

According to the imaging optical lens assembly, when the focal length of the imaging optical lens assembly is f, and the curvature radius of the image-side surface of the third lens element E3 is R6, the following condition is satisfied at the 1st state: f/R6-5.46; the following condition is satisfied at the 2nd state: f/R6=5.44.

According to the imaging optical lens assembly, when the focal length of the imaging optical lens assembly is f, and the curvature radius of the image-side surface of the fourth lens element E4 is R8, the following condition is satisfied at the 1st state: f/R8=3.15; the following condition is satisfied at the 2nd state: f/R8=3.14.

According to the imaging optical lens assembly, when a focal length of the first lens element E1 is f1, and a focal length of the third lens element E3 is f3, the following condition is satisfied at the 1st state: f1/f3=−13.04; the following condition is satisfied at the 2nd state: f1/f3=−13.04.

According to the imaging optical lens assembly, when a focal length of the second lens element E2 is f2, and a curvature radius of the object-side surface of the second lens element E2 is R3, the following condition is satisfied at the 1st state: f2/R3=1.54; the following condition is satisfied at the 2nd state: f2/R3=1.54.

According to the imaging optical lens assembly, when a focal length of the fifth lens element E5 is f5, and a central thickness of the fifth lens element E5 is CT5, the following condition is satisfied at the 1st state: f5/CT5=51.75; the following condition is satisfied at the 2nd state: f5/CT5=51.75.

According to the imaging optical lens assembly, when the focal length of the third lens element E3 is f3, and the focal length of the fifth lens element E5 is f5, the following condition is satisfied at the 1st state: f5/f3=−8.08; the following condition is satisfied at the 2nd state: f5/f3=−8.08.

In FIG. 15B, the imaging optical lens assembly according to the 1st embodiment, when a maximum distance between an optical effective area E21 of the object-side surface of the second lens element E2 and the optical axis is Y21, and a maximum image height of the imaging optical lens assembly is ImgH, the following condition is satisfied at the 1st state: Y21/ImgH=0.78; the following condition is satisfied at the 2nd state: Y21/ImgH=0.78.

According to the imaging optical lens assembly, when the maximum distance between the optical effective area E21 of the object-side surface of the second lens element E2 and the optical axis is Y21, and a maximum distance between an optical effective area of the image-side surface of the sixth lens element E6 and the optical axis is Y62, the following condition is satisfied at the 1st state: Y21/Y62=1.29; the following condition is satisfied at the 2nd state: Y21/Y62=1.29.

### 2nd Embodiment

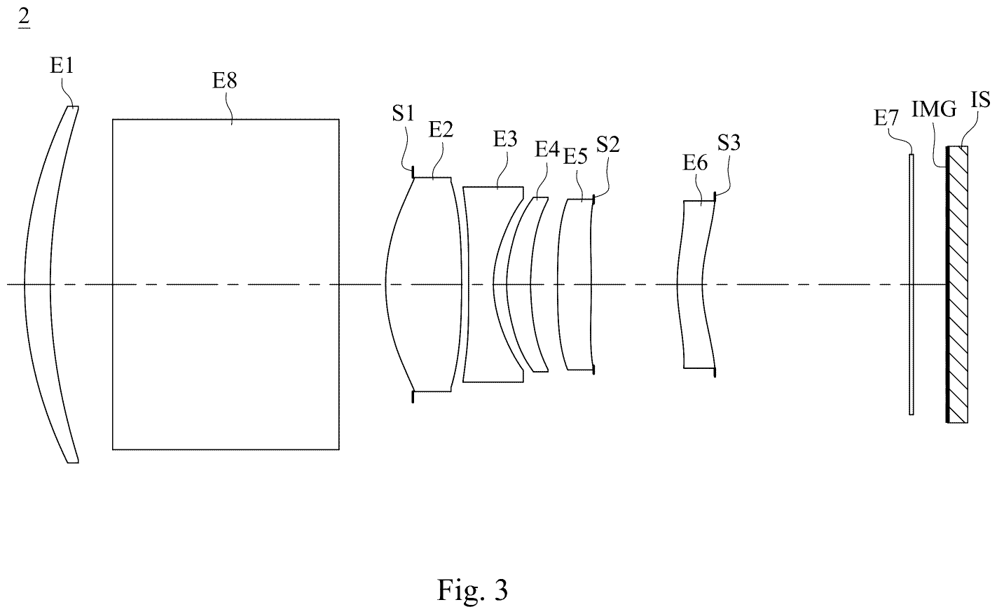

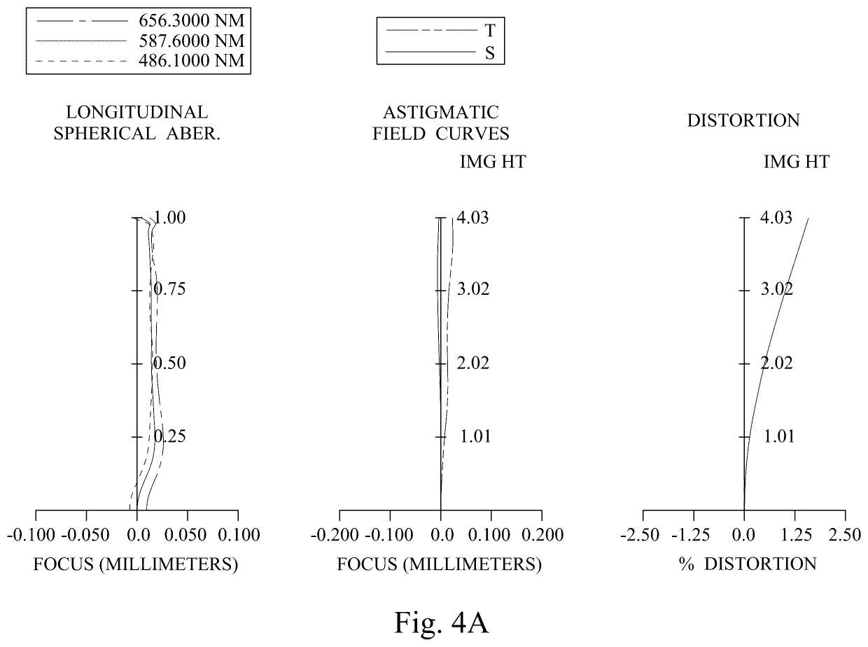

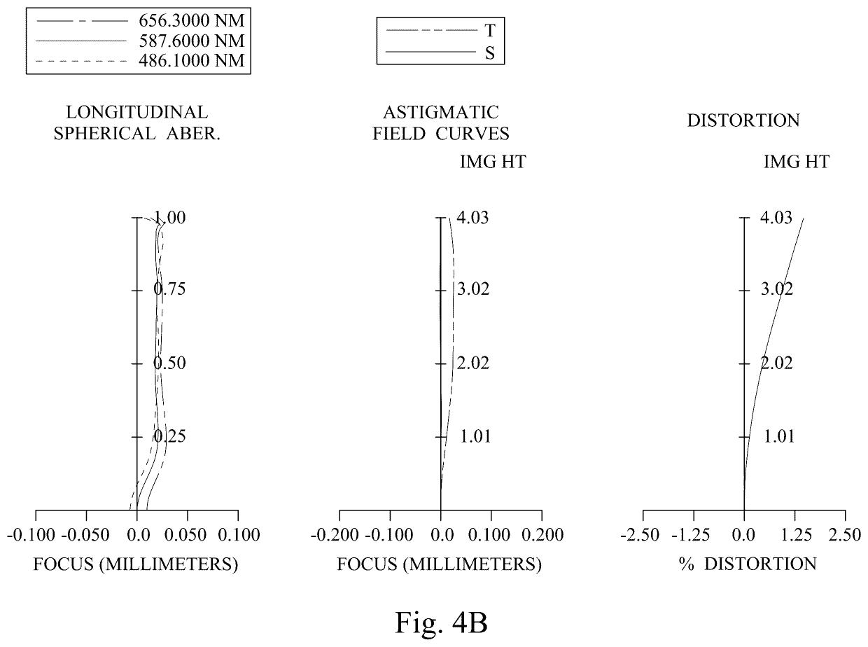

FIG. 3 is a schematic view of an imaging apparatus 2 at the 1st state according to the 2nd embodiment of the present disclosure. FIG. 4A shows spherical aberration curves, astigmatic field curves and a distortion curve of the imaging apparatus 2 at the 1st state according to the 2nd embodiment. FIG. 4B shows spherical aberration curves, astigmatic field curves and a distortion curve of the imaging apparatus 2 at the 2nd state according to the 2nd embodiment. In FIG. 3, the imaging apparatus 2 includes an imaging optical lens assembly (its reference numeral is omitted) and an image sensor IS. The imaging optical lens assembly includes, in order from an object side to an image side along an optical path, a first lens element E1, a light path folding element E8, a stop S1, a second lens element E2, a third lens element E3, a fourth lens element E4, a fifth lens element E5, a stop S2, a sixth lens element E6, a stop S3, a filter E7 and an image surface IMG, wherein the image sensor IS is disposed on the image surface IMG of the imaging optical lens assembly. The imaging optical lens assembly includes six lens elements (E1, E2, E3, E4, E5, E6) without additional one or more lens elements inserted between the first lens element E1 and the sixth lens element E6.

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric.

The second lens element E2 with positive refractive power has an object-side surface being convex in a paraxial region thereof and an image-side surface being convex in a paraxial region thereof. The second lens element E2 is made of plastic material, and has the object-side surface and the image-side surface being both aspheric. Further, the second lens element E2 includes at least one inflection point in an optical effective area thereof.

The third lens element E3 with negative refractive power has an object-side surface being concave in a paraxial region thereof and an image-side surface being concave in a paraxial region thereof. The third lens element E3 is made of plastic material, and has the object-side surface and the image-side surface being both aspheric. Furthermore, the third lens element E3 includes at least one inflection point in an optical effective area thereof.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Furthermore, the fourth lens element E4 includes at least one inflection point in an optical effective area thereof.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Furthermore, the fifth lens element E5 includes at least one inflection point in an optical effective area thereof.

The sixth lens element E6 with negative refractive power has an object-side surface being convex in a paraxial region thereof and an image-side surface being concave in a paraxial region thereof. The sixth lens element E6 is made of plastic material, and has the object-side surface and the image-side surface being both aspheric. Furthermore, the sixth lens element E6 includes at least one inflection point in an optical effective area thereof.

The light path folding element E8 is disposed between the first lens element E1 and the second lens element E2 along the optical axis, which is a prism, and is made of glass material. The light path folding element E8 has a reflective surface, and is rotatable relative to the image sensor IS.

The filter E7 is made of glass material, which is located between the sixth lens element E6 and the image surface IMG in order, and will not affect the focal length of the imaging optical lens assembly.

The imaging optical lens assembly can include at least one reflective surface located between the object-side surface of the first lens element E1 and the object-side surface of the second lens element E2 along the optical axis, which can be similar to the reflective surface in the 1st embodiment, and will not be described again herein. According to the 2nd embodiment, the reflective surface is disposed on the light path folding element E8.

The reflective surface can be rotatable relative to the image sensor IS (such as roll, pitch, or yaw, etc.), which can compensate the relative variation of the location between the image and the image sensor IS, wherein the rotating method can be adjusted on demand. For example, the first lens element E1 can be moved with the light path folding element E8 so as to rotate relative to the image sensor IS, or the light path folding element E8 can be the only one which is rotated relative to the image sensor IS, and the present disclosure will not be limited thereto.

The optical effective area of each surface of each lens element can be non-circular at each state, which can be similar to the 1st embodiment, and will not be stated again herein. According to the 2nd embodiment, the optical effective area of the object-side surface of the second lens element E2 is non-circular at both of the 1st state and the 2nd state.

The optical effective area of each stop can be non-circular at each state, which can be similar to the 1st embodiment, and will not be stated again herein. According to the 2nd embodiment, the optical effective area of the stop S1 is non-circular at both of the 1st state and the 2nd state.

The detailed optical data of the 2nd embodiment are shown in Table 2A and the aspheric surface data are shown in Table 2B below.

TABLE 2A
2nd Embodiment

| Surface | | | | | | | Abbe | Focal |
|---|---|---|---|---|---|---|---|---|
| # | | Curvature Radius | | Thickness | Material | Index | # | Length |
| 0 | Object | Plano | | D0 | | | | |
| 1 | Lens 1 | 10.9353 | ASP | 0.750 | Plastic | 1.545 | 56.1 | 65.20 |
| 2 | | 15.4156 | ASP | 1.818 | | | | |
| 3 | Prism | Plano | | 6.600 | Glass | 1.785 | 25.7 | — |
| 4 | | Plano | | D4 | | | | |
| 5 | Stop | Plano | | −0.793 | | | | |
| 6 | Lens 2 | 5.3263 | ASP | 2.216 | Plastic | 1.545 | 56.1 | 8.66 |
| 7 | | −35.1961 | ASP | 0.203 | | | | |
| 8 | Lens 3 | −200.8032 | ASP | 0.723 | Plastic | 1.615 | 25.3 | −5.28 |
| 9 | | 3.3078 | ASP | 0.387 | | | | |
| 10 | Lens 4 | 3.9569 | ASP | 0.695 | Plastic | 1.566 | 37.4 | 16.38 |
| 11 | | 6.4641 | ASP | 0.787 | | | | |
| 12 | Lens 5 | 31.5147 | ASP | 0.984 | Plastic | 1.697 | 16.3 | 21.73 |
| 13 | | −28.7963 | ASP | 0.072 | | | | |
| 14 | Stop | Plano | | 2.434 | | | | |
| 15 | Lens 6 | 5.6126 | ASP | 0.731 | Plastic | 1.544 | 56.0 | −35.98 |
| 16 | | 4.1617 | ASP | 0.369 | | | | |

| | | | | | | | |
|---|---|---|---|---|---|---|---|
| 17 | Stop | Plano | D17 | | | | |
| 18 | Filter | Plano | 0.110 | Glass | 1.517 | 64.2 | — |
| 19 | | Plano | 1.000 | | | | |
| 20 | Image | Plano | — | | | | |

Reference wavelength is 587.6 nm (d-line).
Prism has a reflective surface.
Maximum distance between the optical effective area of Surface 5 (stop S1) and the optical axis is 3.122 mm.
Maximum distance between the optical effective area of Surface 14 (stop S2) and the optical axis is 2.366 mm.
Maximum distance between the optical effective area of Surface 17 (stop S3) and the optical axis is 2.440 mm.

TABLE 2B
Aspheric Coefficients

| Surface # | 1 | 2 | 6 | 7 |
|---|---|---|---|---|
| k= | −9.05967E−02 | 8.67083E−01 | 3.97755E−02 | 0.00000E+00 |
| A4= | −2.1983271E−04 | −3.1544618E−04 | −1.5231760E−03 | −3.4264050E−03 |
| A6= | 2.9436959E−05 | 3.9026856E−05 | 1.0960050E−04 | −6.0484351E−04 |
| A8= | −3.3022212E−06 | −4.3631771E−06 | −1.8793960E−05 | 3.8520132E−04 |
| A10= | 2.8511281E−07 | 3.8969914E−07 | 1.8361996E−06 | −2.7029967E−05 |
| A12= | −1.5749110E−08 | −2.3236154E−08 | −9.6137328E−08 | −1.6561690E−05 |
| A14= | 4.8236494E−10 | 7.9327155E−10 | −8.6772264E−09 | 4.5137157E−06 |
| A16= | −7.3165849E−12 | −1.3909165E−11 | 4.1773116E−10 | −5.0888740E−07 |
| A18= | 4.0876885E−14 | 9.6122915E−14 | | 2.8254307E−08 |
| A20= | | | | −6.3779495E−10 |
| Surface # | 8 | 9 | 10 | 11 |
| k= | 0.00000E+00 | 4.56199E−02 | −7.05818E−02 | 3.15266E−01 |
| A4= | 2.9726828E−03 | 6.0939267E−03 | −3.6640463E−03 | −3.4692803E−03 |
| A6= | −7.0647149E−03 | −1.5140387E−02 | −7.3597494E−03 | −3.4158054E−03 |
| A8= | 3.1722319E−03 | 7.0802805E−03 | 2.7919479E−03 | 1.6168648E−03 |
| A10= | −7.3446910E−04 | −1.7092171E−03 | 4.8943310E−04 | 6.4596433E−04 |
| A12= | 9.2186581E−05 | 1.6113403E−04 | −6.4340672E−04 | −7.3006158E−04 |
| A14= | −5.0731164E−06 | 2.5904393E−05 | 2.3152652E−04 | 2.9045172E−04 |
| A16= | −1.0402104E−07 | −1.0790925E−05 | −4.6597499E−05 | −6.5249004E−05 |
| A18= | 2.7049690E−08 | 1.5785599E−06 | 5.5687592E−06 | 8.6311225E−06 |
| A20= | −9.8119324E−10 | −1.1200921E−07 | −3.6620804E−07 | −6.2543010E−07 |
| A22= | | 3.0884617E−09 | 1.0106192E−08 | 1.9116602E−08 |
| Surface # | 12 | 13 | 15 | 16 |
| k= | 0.00000E+00 | 0.00000E+00 | 0.00000E+00 | 0.00000E+00 |
| A4= | 7.3365366E−03 | 5.2989064E−03 | −1.2317147E−02 | −1.4747778E−02 |
| A6= | −2.2682060E−03 | −9.8219557E−04 | 8.3033371E−05 | 3.3977248E−04 |
| A8= | 1.2515115E−03 | 5.0462580E−04 | 1.4166798E−04 | 1.3251516E−04 |
| A10= | −4.4033268E−04 | −1.8177574E−04 | −4.1618546E−05 | −4.4928037E−05 |
| A12= | 9.6154014E−05 | 4.0090552E−05 | 7.5979525E−06 | 7.8459978E−06 |
| A14= | −1.2367011E−05 | −4.5928625E−06 | −7.1258152E−07 | −7.4644339E−07 |
| A16= | 8.4998703E−07 | 2.1973973E−07 | 1.8566279E−08 | 2.9545683E−08 |
| A18= | −2.3546593E−08 | | 9.6045572E−10 | |

According to the Table 2A, the values of f, Fno, HFOV, D0, D4 and D17 at the 1st state and at the 2nd state of the imaging optical lens assembly according to the 2nd embodiment are shown in Table 2C.

TABLE 2C
2nd Embodiment

| State | 1st | 2nd |
|---|---|---|
| f (mm) | 19.50 | 19.38 |
| Fno | 2.69 | 2.82 |
| HFOV (deg.) | 11.5 | 11.1 |
| D0 | Infinity | 700.000 |
| D4 | 2.152 | 1.539 |
| D17 | 5.675 | 6.288 |

According to the 2nd embodiment, the second lens element E2 to the sixth lens element E6 can be moved along the optical axis relative to the image sensor IS so as to focus corresponding to the variation of the object distance, but will not be limited thereto. The details can be similar to the 1st embodiment, and will not be stated again herein.

In the 2nd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 2nd embodiment, so an explanation in this regard will not be provided again.

Moreover, these parameters can be calculated from Table 2A, Table 2B and Table 2C as the following values and satisfy the following conditions in Table 2D:

TABLE 2D
2nd Embodiment

| | 1st state | 2nd state | | 1st state | 2nd state |
|---|---|---|---|---|---|
| V2/V3 | 2.21 | 2.21 | \|f/R5\| | 0.10 | 0.10 |
| (T34 + T45)/T56 | 0.47 | 0.47 | f/R6 | 5.90 | 5.86 |
| CT4/CT3 | 0.96 | 0.96 | f/R8 | 3.02 | 3.00 |
| Dr1r4/CT3 | 17.63 | 16.78 | f1/f3 | −12.34 | −12.34 |
| Dr1r4/Dr5r12 | 1.87 | 1.78 | f2/R3 | 1.63 | 1.63 |
| \|R6/R5\| | 0.02 | 0.02 | f5/CT5 | 22.08 | 22.08 |
| R7/\|f4\| | 0.24 | 0.24 | f5/f3 | −4.11 | −4.11 |
| R8/R7 | 1.63 | 1.63 | Y21/ImgH | 0.77 | 0.77 |
| \|f/f6\| | 0.54 | 0.54 | Y21/Y62 | 1.28 | 1.28 |

### 3rd Embodiment

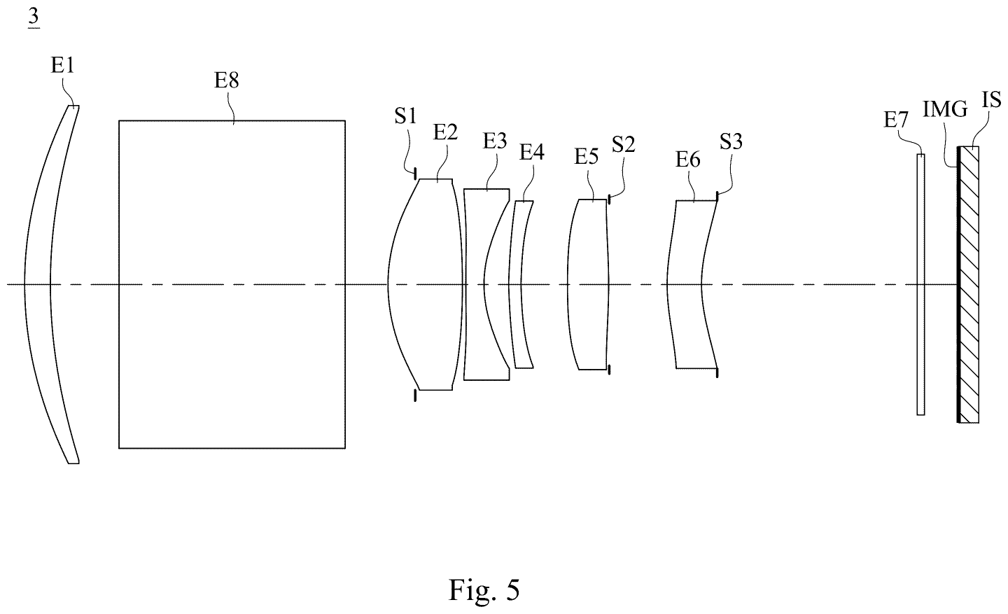

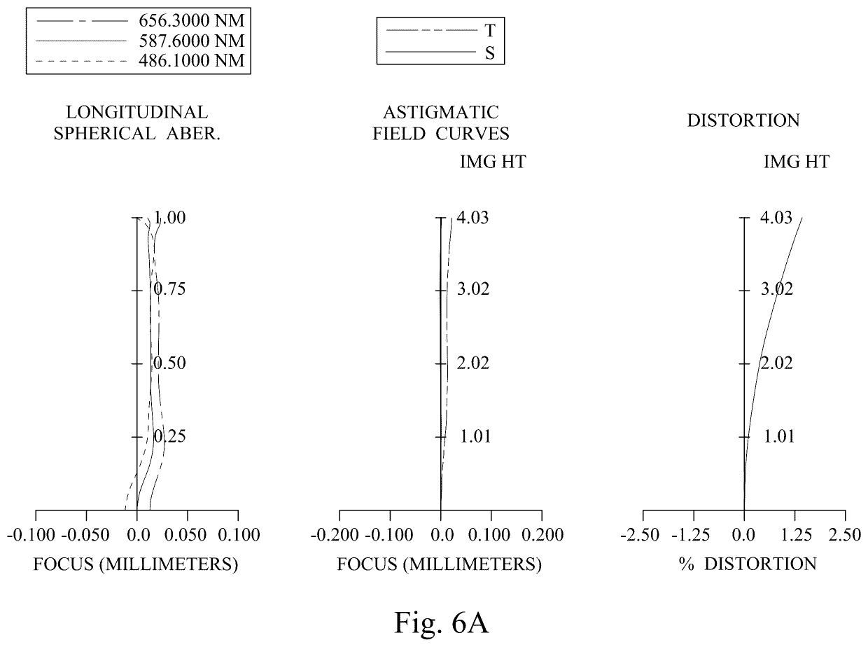

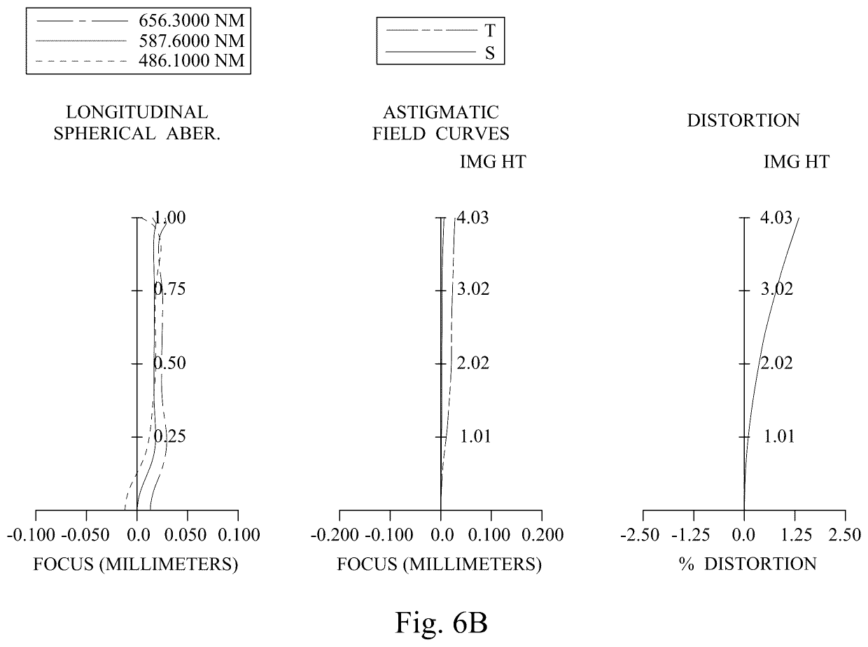

FIG. 5 is a schematic view of an imaging apparatus 3 at the 1st state according to the 3rd embodiment of the present disclosure. FIG. 6A shows spherical aberration curves, astigmatic field curves and a distortion curve of the imaging apparatus 3 at the 1st state according to the 3rd embodiment. FIG. 6B shows spherical aberration curves, astigmatic field curves and a distortion curve of the imaging apparatus 3 at the 2nd state according to the 3rd embodiment. In FIG. 5, the imaging apparatus 3 includes an imaging optical lens assembly (its reference numeral is omitted) and an image sensor IS. The imaging optical lens assembly includes, in order from an object side to an image side along an optical path, a first lens element E1, a light path folding element E8, a stop S1, a second lens element E2, a third lens element E3, a fourth lens element E4, a fifth lens element E5, a stop S2, a sixth lens element E6, a stop S3, a filter E7 and an image surface IMG, wherein the image sensor IS is disposed on the image surface IMG of the imaging optical lens assembly. The imaging optical lens assembly includes six lens elements (E1, E2, E3, E4, E5, E6) without additional one or more lens elements inserted between the first lens element E1 and the sixth lens element E6.

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric.

The second lens element E2 with positive refractive power has an object-side surface being convex in a paraxial region thereof and an image-side surface being convex in a paraxial region thereof. The second lens element E2 is made of plastic material, and has the object-side surface and the image-side surface being both aspheric. Further, the second lens element E2 includes at least one inflection point in an optical effective area thereof.

The third lens element E3 with negative refractive power has an object-side surface being convex in a paraxial region thereof and an image-side surface being concave in a paraxial region thereof. The third lens element E3 is made of plastic material, and has the object-side surface and the image-side surface being both aspheric. Furthermore, the third lens element E3 includes at least one inflection point in an optical effective area thereof.

The fourth lens element E4 with negative refractive power has an object-side surface being convex in a paraxial region thereof and an image-side surface being concave in a paraxial region thereof. The fourth lens element E4 is made of plastic material, and has the object-side surface and the image-side surface being both aspheric. Furthermore, the fourth lens element E4 includes at least one inflection point in an optical effective area thereof.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Furthermore, the fifth lens element E5 includes at least one inflection point in an optical effective area thereof.

The sixth lens element E6 with negative refractive power has an object-side surface being convex in a paraxial region thereof and an image-side surface being concave in a paraxial region thereof. The sixth lens element E6 is made of plastic material, and has the object-side surface and the image-side surface being both aspheric. Furthermore, the sixth lens element E6 includes at least one inflection point in an optical effective area thereof.

The light path folding element E8 is disposed between the first lens element E1 and the second lens element E2 along the optical axis, which is a prism, and is made of glass material. The light path folding element E8 has a reflective surface, and is rotatable relative to the image sensor IS.

The filter E7 is made of glass material, which is located between the sixth lens element E6 and the image surface IMG in order, and will not affect the focal length of the imaging optical lens assembly.

The imaging optical lens assembly can include at least one reflective surface located between the object-side surface of the first lens element E1 and the object-side surface of the second lens element E2 along the optical axis, which can be similar to the reflective surface in the 1st embodiment, and will not be described again herein. According to the 3rd embodiment, the reflective surface is disposed on the light path folding element E8.

The reflective surface can be rotatable relative to the image sensor IS (such as roll, pitch, or yaw, etc.), which can compensate the relative variation of the location between the image and the image sensor IS, wherein the rotating method can be adjusted on demand. For example, the first lens element E1 can be moved with the light path folding element E8 so as to rotate relative to the image sensor IS, or the light path folding element E8 can be the only one which is rotated relative to the image sensor IS, and the present disclosure will not be limited thereto.

The optical effective area of each surface of each lens element can be non-circular at each state, which can be similar to the 1st embodiment, and will not be stated again herein. According to the 3rd embodiment, the optical effective area of the object-side surface of the second lens element E2 is non-circular at both of the 1st state and the 2nd state.

The optical effective area of each stop can be non-circular at each state, which can be similar to the 1st embodiment, and will not be stated again herein. According to the 3rd embodiment, the optical effective area of the stop S1 is non-circular at both of the 1st state and the 2nd state.

The detailed optical data of the 3rd embodiment are shown in Table 3A and the aspheric surface data are shown in Table 3B below.

TABLE 3A
3rd Embodiment

| Surface | | | | | | | Abbe | Focal |
|---|---|---|---|---|---|---|---|---|
| # | | Curvature Radius | | Thickness | Material | Index | # | Length |
| 0 | Object | Plano | | D0 | | | | |
| 1 | Lens 1 | 10.6647 | ASP | 0.753 | Plastic | 1.545 | 56.1 | 65.04 |
| 2 | | 14.8748 | ASP | 2.001 | | | | |
| 3 | Prism | Plano | | 6.600 | Glass | 1.785 | 25.7 | — |
| 4 | | Plano | | D4 | | | | |
| 5 | Stop | Plano | | −0.793 | | | | |
| 6 | Lens 2 | 4.8450 | ASP | 2.171 | Plastic | 1.545 | 56.1 | 7.74 |
| 7 | | −27.5309 | ASP | 0.100 | | | | |
| 8 | Lens 3 | 45.9190 | ASP | 0.531 | Plastic | 1.615 | 25.4 | −6.22 |
| 9 | | 3.5135 | ASP | 0.721 | | | | |
| 10 | Lens 4 | 8.6377 | ASP | 0.360 | Plastic | 1.587 | 28.3 | −992.42 |
| 11 | | 8.3803 | ASP | 1.354 | | | | |
| 12 | Lens 5 | 19.9461 | ASP | 1.200 | Plastic | 1.669 | 19.5 | 15.09 |
| 13 | | −19.9538 | ASP | 0.022 | | | | |
| 14 | Stop | Plano | | 1.687 | | | | |
| 15 | Lens 6 | 5.6222 | ASP | 1.003 | Plastic | 1.669 | 19.5 | −31.92 |
| 16 | | 4.1324 | ASP | 0.457 | | | | |

| | | | | | | | |
|---|---|---|---|---|---|---|---|
| 17 | Stop | Plano | D17 | | | | |
| 18 | Filter | Plano | 0.210 | Glass | 1.517 | 64.2 | — |
| 19 | | Plano | 1.000 | | | | |
| 20 | Image | Plano | — | | | | |

Reference wavelength is 587.6 nm (d-line).
Prism has a reflective surface.
Maximum distance between the optical effective area of Surface 5 (stop S1) and the optical axis is 3.080 mm.
Maximum distance between the optical effective area of Surface 14 (stop S2) and the optical axis is 2.366 mm.
Maximum distance between the optical effective area of Surface 17 (stop S3) and the optical axis is 2.450 mm.

TABLE 3B
Aspheric Coefficients

| Surface # | 1 | 2 | 6 | 7 |
|---|---|---|---|---|
| k= | −2.14695E−01 | 1.90828E−01 | −3.00074E−02 | 0.00000E+00 |
| A4= | −2.6925902E−04 | −3.7913081E−04 | −1.6009864E−03 | −4.8270719E−03 |
| A6= | 2.5545348E−05 | 3.6823807E−05 | 9.0799336E−05 | 1.2625045E−03 |
| A8= | −1.7699951E−06 | −2.7249996E−06 | −2.9348488E−06 | −2.5020489E−04 |
| A10= | 1.0910360E−07 | 1.7921328E−07 | −2.8009734E−06 | 6.8309132E−05 |
| A12= | −4.9076352E−09 | −9.0777900E−09 | 5.6056483E−07 | −2.0736010E−05 |
| A14= | 1.1419319E−10 | 2.6623470E−10 | −5.7910360E−08 | 3.8245952E−06 |
| A16= | −1.0365608E−12 | −3.8917313E−12 | 1.8072092E−09 | −3.9144195E−07 |
| A18= | 1.3669583E−16 | 2.1303475E−14 | | 2.0913803E−08 |
| A20= | | | | −4.5853773E−10 |
| Surface # | 8 | 9 | 10 | 11 |
| k= | 0.00000E+00 | 4.13727E−02 | −9.95034E−01 | 1.29571E−01 |
| A4= | 2.4091026E−04 | 2.8609620E−03 | −6.6071454E−03 | −3.8540538E−03 |
| A6= | −4.3830412E−03 | −9.2434572E−03 | −3.9477137E−03 | −2.9850117E−03 |
| A8= | 2.0004168E−03 | 3.6153924E−03 | 1.7399663E−03 | 2.1903641E−03 |
| A10= | −4.5396239E−04 | −8.0385167E−04 | 1.0264856E−04 | −4.3701265E−04 |
| A12= | 5.0943333E−05 | 1.1973149E−04 | −1.5501340E−04 | 6.6674353E−05 |
| A14= | −1.2726862E−06 | −1.8544267E−05 | 2.2270917E−05 | −3.2216354E−05 |
| A16= | −2.9383340E−07 | 3.3888226E−06 | 1.8630398E−06 | 1.1000794E−05 |
| A18= | 2.9016930E−08 | −4.3305742E−07 | −7.8858450E−07 | −1.8409006E−06 |
| A20= | −8.2262560E−10 | 2.9630287E−08 | 7.7621725E−08 | 1.5064145E−07 |
| A22= | | −8.8239977E−10 | −2.7159965E−09 | −4.9048360E−09 |
| Surface # | 12 | 13 | 15 | 16 |
| k= | 0.00000E+00 | 0.00000E+00 | 0.00000E+00 | 0.00000E+00 |
| A4= | 6.1151396E−03 | 2.4616285E−03 | −1.0026777E−02 | −1.2241663E−02 |
| A6= | −7.6089337E−04 | −3.2654254E−04 | 1.4171030E−04 | 3.6876283E−04 |
| A8= | 2.4019594E−04 | 1.4290889E−04 | 5.2067391E−05 | 7.0018333E−05 |
| A10= | −5.4442042E−05 | −3.5977393E−05 | −3.4525933E−06 | −2.3083066E−05 |
| A12= | 7.2687127E−06 | 6.1614406E−06 | −1.4483430E−06 | 3.7471031E−06 |
| A14= | −4.3253473E−07 | −5.5875854E−07 | 4.7886010E−07 | −3.4093387E−07 |
| A16= | −3.1918202E−10 | 2.1906574E−08 | −5.9381777E−08 | 1.2937170E−08 |
| A18= | 8.6708926E−10 | | 2.6985431E−09 | |

According to the Table 3A, the values of f, Fno, HFOV, D0, D4 and D17 at the 1st state and at the 2nd state of the imaging optical lens assembly according to the 3rd embodiment are shown in Table 3C.

TABLE 3C
3rd Embodiment

| State | 1st | 2nd |
|---|---|---|
| f (mm) | 19.12 | 19.04 |
| Fno | 2.66 | 2.75 |
| HFOV (deg.) | 11.7 | 11.5 |
| D0 | Infinity | 1000.000 |
| D4 | 2.043 | 1.635 |
| D17 | 5.838 | 6.246 |

According to the 3rd embodiment, the second lens element E2 to the sixth lens element E6 can be moved along the optical axis relative to the image sensor IS so as to focus corresponding to the variation of the object distance, but will not be limited thereto. The details can be similar to the 1st embodiment, and will not be stated again herein.

In the 3rd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 3rd embodiment, so an explanation in this regard will not be provided again.

Moreover, these parameters can be calculated from Table 3A, Table 3B and Table 3C as the following values and satisfy the following conditions in Table 3D:

TABLE 3D
3rd Embodiment

| | 1st state | 2nd state | | 1st state | 2nd state |
|---|---|---|---|---|---|
| V2/V3 | 2.21 | 2.21 | \|f/R5\| | 0.42 | 0.41 |
| (T34 + T45)/T56 | 1.21 | 1.21 | f/R6 | 5.44 | 5.42 |
| CT4/CT3 | 0.68 | 0.68 | f/R8 | 2.28 | 2.27 |
| Dr1r4/CT3 | 24.06 | 23.29 | f1/f3 | −10.46 | −10.46 |
| Dr1r4/Dr5r12 | 1.86 | 1.80 | f2/R3 | 1.60 | 1.60 |
| \|R6/R5\| | 0.08 | 0.08 | f5/CT5 | 12.58 | 12.58 |
| R7/\|f4\| | 0.01 | 0.01 | f5/f3 | −2.43 | −2.43 |
| R8/R7 | 0.97 | 0.97 | Y21/ImgH | 0.76 | 0.76 |
| \|f/f6\| | 0.60 | 0.60 | Y21/Y62 | 1.26 | 1.26 |

### 4th Embodiment

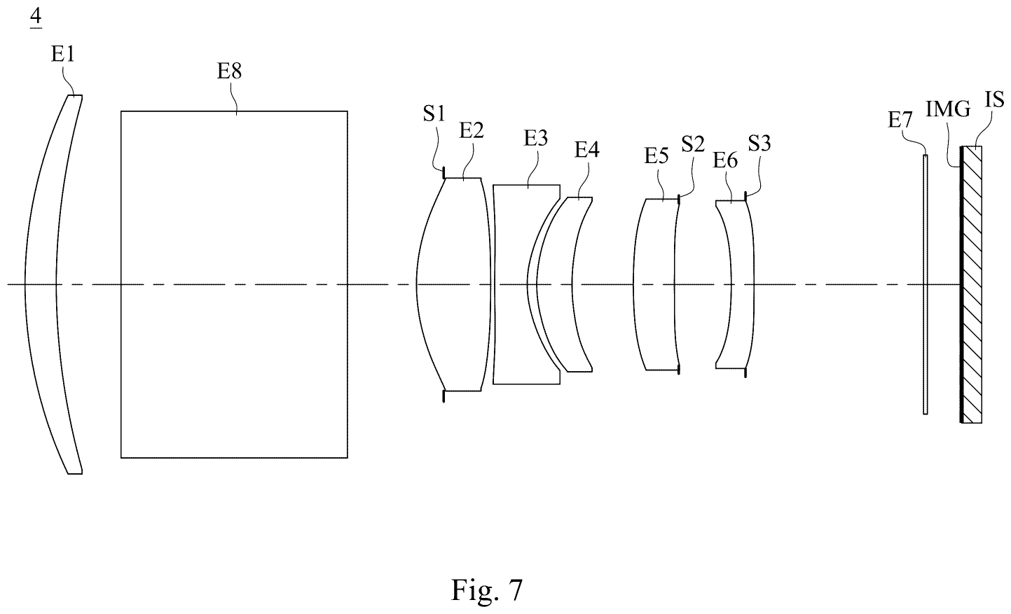

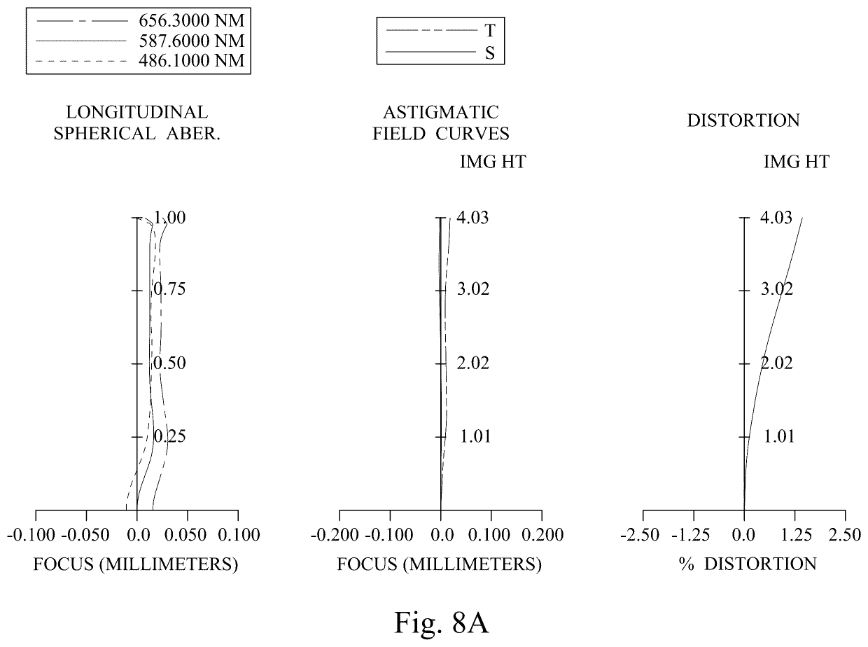

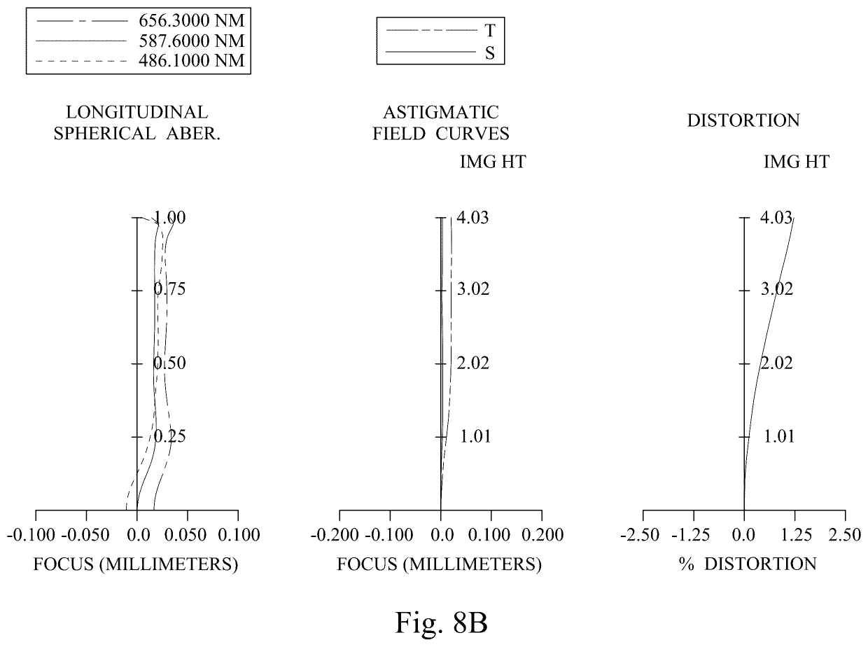

FIG. 7 is a schematic view of an imaging apparatus 4 at the 1st state according to the 4th embodiment of the present disclosure. FIG. 8A shows spherical aberration curves, astigmatic field curves and a distortion curve of the imaging apparatus 4 at the 1st state according to the 4th embodiment. FIG. 8B shows spherical aberration curves, astigmatic field curves and a distortion curve of the imaging apparatus 4 at the 2nd state according to the 4th embodiment. In FIG. 7, the imaging apparatus 4 includes an imaging optical lens assembly (its reference numeral is omitted) and an image sensor IS. The imaging optical lens assembly includes, in order from an object side to an image side along an optical path, a first lens element E1, a light path folding element E8, a stop S1, a second lens element E2, a third lens element E3, a fourth lens element E4, a fifth lens element E5, a stop S2, a sixth lens element E6, a stop S3, a filter E7 and an image surface IMG, wherein the image sensor IS is disposed on the image surface IMG of the imaging optical lens assembly. The imaging optical lens assembly includes six lens elements (E1, E2, E3, E4, E5, E6) without additional one or more lens elements inserted between the first lens element E1 and the sixth lens element E6.

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric.

The second lens element E2 with positive refractive power has an object-side surface being convex in a paraxial region thereof and an image-side surface being convex in a paraxial region thereof. The second lens element E2 is made of plastic material, and has the object-side surface and the image-side surface being both aspheric. Further, the second lens element E2 includes at least one inflection point in an optical effective area thereof.

The third lens element E3 with negative refractive power has an object-side surface being convex in a paraxial region thereof and an image-side surface being concave in a paraxial region thereof. The third lens element E3 is made of plastic material, and has the object-side surface and the image-side surface being both aspheric. Furthermore, the third lens element E3 includes at least one inflection point in an optical effective area thereof.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Furthermore, the fourth lens element E4 includes at least one inflection point in an optical effective area thereof.

The fifth lens element E5 with positive refractive power has an object-side surface being convex in a paraxial region thereof and an image-side surface being concave in a paraxial region thereof. The fifth lens element E5 is made of plastic material, and has the object-side surface and the image-side surface being both aspheric.

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric.

The light path folding element E8 is disposed between the first lens element E1 and the second lens element E2 along the optical axis, which is a prism, and is made of glass material. The light path folding element E8 has a reflective surface, and is rotatable relative to the image sensor IS.

The filter E7 is made of glass material, which is located between the sixth lens element E6 and the image surface IMG in order, and will not affect the focal length of the imaging optical lens assembly.

The imaging optical lens assembly can include at least one reflective surface located between the object-side surface of the first lens element E1 and the object-side surface of the second lens element E2 along the optical axis, which can be similar to the reflective surface in the 1st embodiment, and will not be described again herein. According to the 4th embodiment, the reflective surface is disposed on the light path folding element E8.

The reflective surface can be rotatable relative to the image sensor IS (such as roll, pitch, or yaw, etc.), which can compensate the relative variation of the location between the image and the image sensor IS, wherein the rotating method can be adjusted on demand. For example, the first lens element E1 can be moved with the light path folding element E8 so as to rotate relative to the image sensor IS, or the light path folding element E8 can be the only one which is rotated relative to the image sensor IS, and the present disclosure will not be limited thereto.

The optical effective area of each surface of each lens element can be non-circular at each state, which can be similar to the 1st embodiment, and will not be stated again herein. According to the 4th embodiment, the optical effective area of the object-side surface of the second lens element E2 is non-circular at both of the 1st state and the 2nd state.

The optical effective area of each stop can be non-circular at each state, which can be similar to the 1st embodiment, and will not be stated again herein. According to the 4th embodiment, the optical effective area of the stop S1 is non-circular at both of the 1st state and the 2nd state.

The detailed optical data of the 4th embodiment are shown in Table 4A and the aspheric surface data are shown in Table 4B below.

TABLE 4A
4th Embodiment

| Surface | | | | | | | Abbe | Focal |
|---|---|---|---|---|---|---|---|---|
| # | | Curvature Radius | | Thickness | Material | Index | # | Length |
| 0 | Object | Plano | | D0 | | | | |
| 1 | Lens 1 | 12.1233 | ASP | 0.910 | Plastic | 1.545 | 56.1 | 65.58 |
| 2 | | 17.8613 | ASP | 1.890 | | | | |
| 3 | Prism | Plano | | 6.600 | Glass | 1.785 | 25.7 | — |
| 4 | | Plano | | D4 | | | | |
| 5 | Stop | Plano | | −0.795 | | | | |
| 6 | Lens 2 | 5.2477 | ASP | 2.162 | Plastic | 1.545 | 56.1 | 8.86 |
| 7 | | −51.8218 | ASP | 0.119 | | | | |
| 8 | Lens 3 | 46.8191 | ASP | 0.949 | Plastic | 1.587 | 28.3 | −5.77 |
| 9 | | 3.1339 | ASP | 0.276 | | | | |
| 10 | Lens 4 | 3.5851 | ASP | 1.028 | Plastic | 1.544 | 56.0 | 16.31 |
| 11 | | 5.4075 | ASP | 1.787 | | | | |
| 12 | Lens 5 | 12.8956 | ASP | 1.200 | Plastic | 1.686 | 18.4 | 19.98 |
| 13 | | 208.6376 | ASP | 0.126 | | | | |
| 14 | Stop | Plano | | 1.532 | | | | |
| 15 | Lens 6 | −11.1682 | ASP | 0.663 | Plastic | 1.544 | 56.0 | −21.80 |
| 16 | | −195.7713 | ASP | −0.249 | | | | |

| | | | | | | | |
|---|---|---|---|---|---|---|---|
| 17 | Stop | Plano | D17 | | | | |
| 18 | Filter | Plano | 0.110 | Glass | 1.517 | 64.2 | — |
| 19 | | Plano | 1.000 | | | | |
| 20 | Image | Plano | — | | | | |

Reference wavelength is 587.6 nm (d-line).
Prism has a reflective surface.
Maximum distance between the optical effective area of Surface 5 (stop S1) and the optical axis is 3.103 mm.
Maximum distance between the optical effective area of Surface 14 (stop S2) and the optical axis is 2.366 mm.
Maximum distance between the optical effective area of Surface 17 (stop S3) and the optical axis is 2.450 mm.

TABLE 4B
Aspheric Coefficients

| Surface # | 1 | 2 | 6 | 7 |
|---|---|---|---|---|
| k= | −1.98839E−01 | 3.47991E−01 | 2.19442E−02 | 0.00000E+00 |
| A4= | −2.8589201E−04 | −3.9578216E−04 | −1.6158652E−03 | −3.3842878E−03 |
| A6= | 2.0795603E−05 | 2.9770228E−05 | 1.2708361E−04 | −1.4819155E−03 |
| A8= | −1.5538066E−06 | −2.1910897E−06 | −2.4036544E−05 | 1.0295436E−03 |
| A10= | 1.1352605E−07 | 1.5966704E−07 | 3.6115825E−06 | −2.5282439E−04 |
| A12= | −5.4664814E−09 | −8.1809735E−09 | −4.1508674E−07 | 2.9883334E−05 |
| A14= | 1.4920813E−10 | 2.4602904E−10 | 1.9185665E−08 | −1.3700681E−06 |
| A16= | −2.0468743E−12 | −3.8531932E−12 | −5.4562758E−10 | −5.5537527E−08 |
| A18= | 1.0155843E−14 | 2.3533172E−14 | | 8.6396885E−09 |
| A20= | | | | −2.7014360E−10 |
| Surface # | 8 | 9 | 10 | 11 |
| k= | 0.00000E+00 | 1.52130E−02 | −7.59697E−02 | 1.83916E−01 |
| A4= | 2.1853365E−03 | 2.9492112E−03 | −6.9140762E−03 | −8.8775193E−03 |
| A6= | −5.6122782E−03 | −1.0259600E−02 | −2.8797475E−03 | 2.1497035E−03 |
| A8= | 2.3713710E−03 | 3.8888178E−03 | 1.3886584E−03 | −3.1339823E−04 |
| A10= | −4.8160280E−04 | −8.5303606E−04 | −1.7162882E−04 | 4.7483119E−04 |
| A12= | 4.1097116E−05 | 1.7754037E−04 | 5.0466017E−05 | −3.2773662E−04 |
| A14= | 1.6991711E−06 | −4.7634547E−05 | −2.8856707E−05 | 1.3344740E−04 |
| A16= | −6.7583285E−07 | 1.0030690E−05 | 6.8956560E−06 | −3.4998057E−05 |
| A18= | 5.4820284E−08 | −1.2160274E−06 | −7.3939480E−07 | 5.6197493E−06 |
| A20= | −1.5667600E−09 | 7.6240609E−08 | 3.3518190E−08 | −4.9563235E−07 |
| A22= | | −2.0141038E−09 | −4.3373678E−10 | 1.8256302E−08 |
| Surface # | 12 | 13 | 15 | 16 |
| k= | 0.00000E+00 | 0.00000E+00 | 0.00000E+00 | 0.00000E+00 |
| A4= | 8.7303283E−04 | 2.6402635E−03 | −7.0766470E−03 | −6.9325593E−03 |
| A6= | 7.1284832E−04 | 4.2546828E−04 | 1.3666214E−04 | 1.0141643E−04 |
| A8= | −8.9659964E−05 | 1.1012767E−05 | −1.9451939E−05 | 7.4226190E−05 |
| A10= | 5.4403305E−05 | 1.7150372E−06 | 1.8321986E−05 | −3.2126107E−05 |
| A12= | −2.2052271E−05 | −3.3930936E−06 | −1.4954536E−05 | 5.2152211E−06 |
| A14= | 4.1912066E−06 | 4.8188008E−07 | 3.8274878E−06 | −4.3555598E−07 |
| A16= | −3.9751621E−07 | −2.3834591E−08 | −4.6488303E−07 | 1.4571947E−08 |
| A18= | 1.5170507E−08 | | 2.1258359E−08 | |

According to the Table 4A, the values of f, Fno, HFOV, D0, D4 and D17 at the 1st state and at the 2nd state of the imaging optical lens assembly according to the 4th embodiment are shown in Table 4C.

TABLE 4C
4th Embodiment

| State | 1st | 2nd |
|---|---|---|
| f (mm) | 19.60 | 19.50 |
| Fno | 2.67 | 2.78 |
| HFOV (deg.) | 11.5 | 11.1 |
| D0 | Infinity | 900.000 |
| D4 | 2.809 | 2.329 |
| D17 | 5.192 | 5.672 |

According to the 4th embodiment, the second lens element E2 to the sixth lens element E6 can be moved along the optical axis relative to the image sensor IS so as to focus corresponding to the variation of the object distance, but will not be limited thereto. The details can be similar to the 1st embodiment, and will not be stated again herein.

In the 4th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 4th embodiment, so an explanation in this regard will not be provided again.

Moreover, these parameters can be calculated from Table 4A, Table 4B and Table 4C as the following values and satisfy the following conditions in Table 4D:

TABLE 4D
4th Embodiment

| | 1st state | 2nd state | | 1st state | 2nd state |
|---|---|---|---|---|---|
| V2/V3 | 1.98 | 1.98 | \|f/R5\| | 0.42 | 0.42 |
| (T34 + T45)/T56 | 1.24 | 1.24 | f/R6 | 6.25 | 6.22 |
| CT4/CT3 | 1.08 | 1.08 | f/R8 | 3.62 | 3.61 |
| Dr1r4/CT3 | 14.31 | 13.80 | f1/f3 | −11.37 | −11.37 |
| Dr1r4/Dr5r12 | 1.80 | 1.73 | f2/R3 | 1.69 | 1.69 |
| \|R6/R5\| | 0.07 | 0.07 | f5/CT5 | 16.65 | 16.65 |
| R7/\|f4\| | 0.22 | 0.22 | f5/f3 | −3.47 | −3.47 |
| R8/R7 | 1.51 | 1.51 | Y21/ImgH | 0.77 | 0.77 |
| \|f/f6\| | 0.90 | 0.89 | Y21/Y62 | 1.27 | 1.27 |

### 5th Embodiment

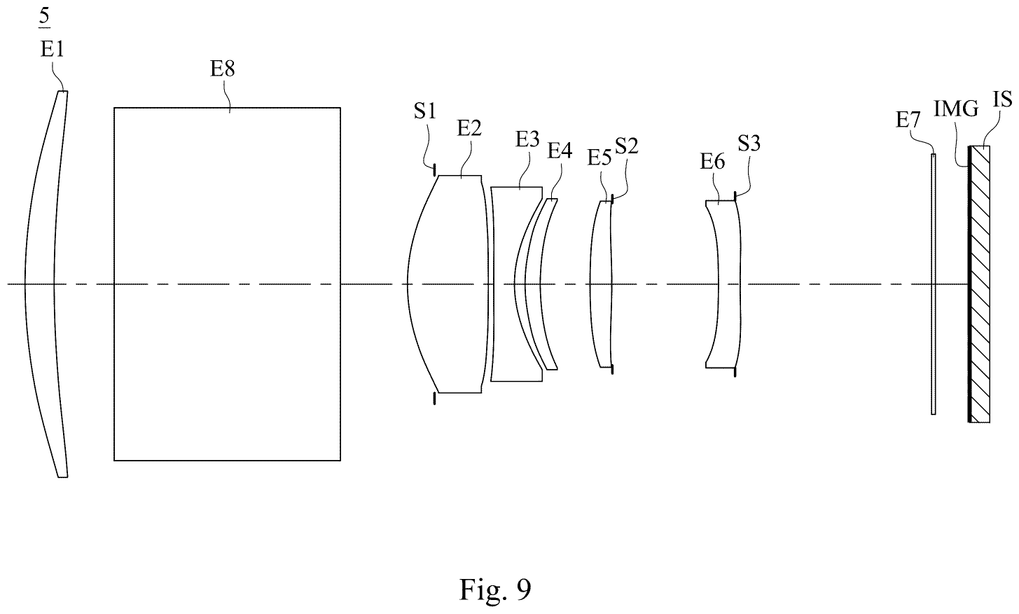

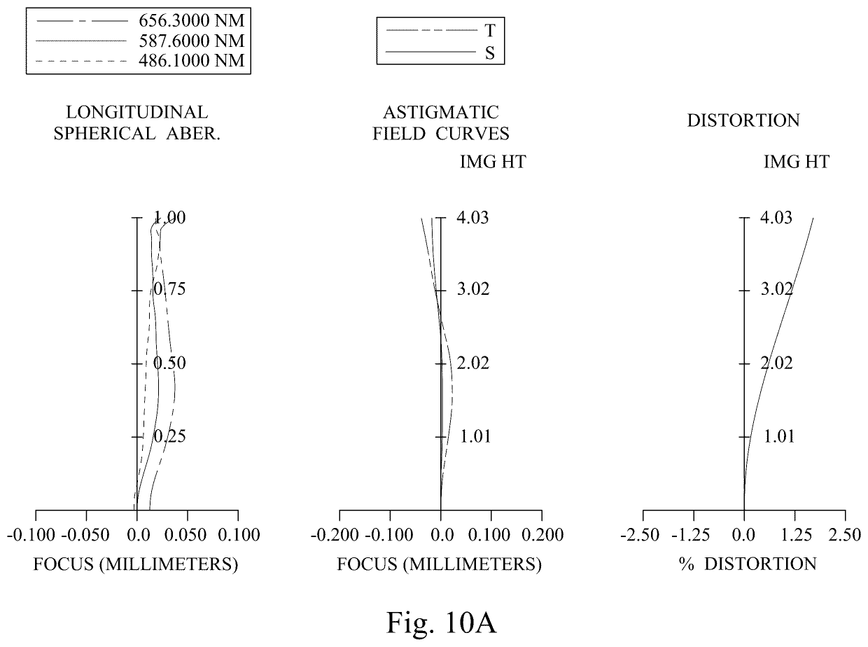

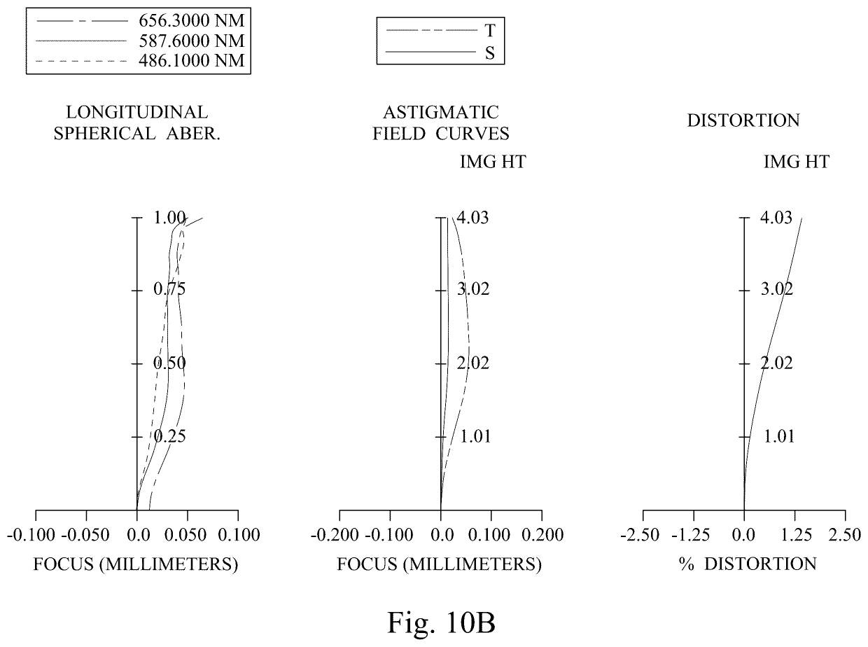

FIG. 9 is a schematic view of an imaging apparatus 5 at the 1st state according to the 5th embodiment of the present disclosure. FIG. 10A shows spherical aberration curves, astigmatic field curves and a distortion curve of the imaging apparatus 5 at the 1st state according to the 5th embodiment. FIG. 10B shows spherical aberration curves, astigmatic field curves and a distortion curve of the imaging apparatus 5 at the 2nd state according to the 5th embodiment. In FIG. 9, the imaging apparatus 5 includes an imaging optical lens assembly (its reference numeral is omitted) and an image sensor IS. The imaging optical lens assembly includes, in order from an object side to an image side along an optical path, a first lens element E1, a light path folding element E8, a stop S1, a second lens element E2, a third lens element E3, a fourth lens element E4, a fifth lens element E5, a stop S2, a sixth lens element E6, a stop S3, a filter E7 and an image surface IMG, wherein the image sensor IS is disposed on the image surface IMG of the imaging optical lens assembly. The imaging optical lens assembly includes six lens elements (E1, E2, E3, E4, E5, E6) without additional one or more lens elements inserted between the first lens element E1 and the sixth lens element E6.

The first lens element E1 with positive refractive power has an object-side surface being convex in a paraxial region thereof and an image-side surface being concave in a paraxial region thereof. The first lens element E1 is made of plastic material, and has the object-side surface and the image-side surface being both aspheric.

The second lens element E2 with positive refractive power has an object-side surface being convex in a paraxial region thereof and an image-side surface being convex in a paraxial region thereof. The second lens element E2 is made of plastic material, and has the object-side surface and the image-side surface being both aspheric. Further, the second lens element E2 includes at least one inflection point in an optical effective area thereof.

The third lens element E3 with negative refractive power has an object-side surface being convex in a paraxial region thereof and an image-side surface being concave in a paraxial region thereof. The third lens element E3 is made of plastic material, and has the object-side surface and the image-side surface being both aspheric. Furthermore, the third lens element E3 includes at least one inflection point in an optical effective area thereof.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Furthermore, the fourth lens element E4 includes at least one inflection point in an optical effective area thereof.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Furthermore, the fifth lens element E5 includes at least one inflection point in an optical effective area thereof.

The sixth lens element E6 with negative refractive power has an object-side surface being concave in a paraxial region thereof and an image-side surface being concave in a paraxial region thereof. The sixth lens element E6 is made of plastic material, and has the object-side surface and the image-side surface being both aspheric. Furthermore, the sixth lens element E6 includes at least one inflection point in an optical effective area thereof.

The light path folding element E8 is disposed between the first lens element E1 and the second lens element E2 along the optical axis, which is a prism, and is made of glass material. The light path folding element E8 has a reflective surface, and is rotatable relative to the image sensor IS.

The filter E7 is made of glass material, which is located between the sixth lens element E6 and the image surface IMG in order, and will not affect the focal length of the imaging optical lens assembly.

The imaging optical lens assembly can include at least one reflective surface located between the object-side surface of the first lens element E1 and the object-side surface of the second lens element E2 along the optical axis, which can be similar to the reflective surface in the 1st embodiment, and will not be described again herein. According to the 5th embodiment, the reflective surface is disposed on the light path folding element E8.

The reflective surface can be rotatable relative to the image sensor IS (such as roll, pitch, or yaw, etc.), which can compensate the relative variation of the location between the image and the image sensor IS, wherein the rotating method can be adjusted on demand. For example, the first lens element E1 can be moved with the light path folding element E8 so as to rotate relative to the image sensor IS, or the light path folding element E8 can be the only one which is rotated relative to the image sensor IS, and the present disclosure will not be limited thereto.

The optical effective area of each surface of each lens element can be non-circular at each state, which can be similar to the 1st embodiment, and will not be stated again herein. According to the 5th embodiment, the optical effective area of the object-side surface of the second lens element E2 is non-circular at both of the 1st state and the 2nd state.

The optical effective area of each stop can be non-circular at each state, which can be similar to the 1st embodiment, and will not be stated again herein. According to the 5th embodiment, the optical effective area of the stop S1 is non-circular at both of the 1st state and the 2nd state.

The detailed optical data of the 5th embodiment are shown in Table 5A and the aspheric surface data are shown in Table 5B below.

TABLE 5A
5th Embodiment

| Surface | | | | | | | Abbe | Focal |
|---|---|---|---|---|---|---|---|---|
| # | | Curvature Radius | | Thickness | Material | Index | # | Length |
| 0 | Object | Plano | | D0 | | | | |
| 1 | Lens 1 | 14.8577 | ASP | 0.849 | Plastic | 1.545 | 56.1 | 56.15 |
| 2 | | 28.2978 | ASP | 1.751 | | | | |
| 3 | Prism | Plano | | 6.600 | Glass | 1.785 | 25.7 | — |
| 4 | | Plano | | D4 | | | | |
| 5 | Stop | Plano | | −0.789 | | | | |
| 6 | Lens 2 | 5.0975 | ASP | 2.356 | Plastic | 1.545 | 56.1 | 9.19 |
| 7 | | −234.9722 | ASP | 0.159 | | | | |
| 8 | Lens 3 | 60.3116 | ASP | 0.605 | Plastic | 1.614 | 25.6 | −5.78 |
| 9 | | 3.3374 | ASP | 0.310 | | | | |
| 10 | Lens 4 | 4.3703 | ASP | 0.441 | Plastic | 1.544 | 56.0 | 24.87 |
| 11 | | 6.2262 | ASP | 1.454 | | | | |
| 12 | Lens 5 | 21.5655 | ASP | 0.633 | Plastic | 1.660 | 20.4 | 15.55 |
| 13 | | −19.3598 | ASP | 0.020 | | | | |
| 14 | Stop | Plano | | 3.094 | | | | |
| 15 | Lens 6 | −22.7499 | ASP | 0.633 | Plastic | 1.544 | 56.0 | −22.74 |
| 16 | | 27.3892 | ASP | −0.149 | | | | |

| | | | | | | | |
|---|---|---|---|---|---|---|---|
| 17 | Stop | Plano | D17 | | | | |
| 18 | Filter | Plano | 0.110 | Glass | 1.517 | 64.2 | — |
| 19 | | Plano | 1.000 | | | | |
| 20 | Image | Plano | — | | | | |

Reference wavelength is 587.6 nm (d-line).
Prism has a reflective surface.
Maximum distance between the optical effective area of Surface 5 (stop S1) and the optical axis is 3.174 mm.
Maximum distance between the optical effective area of Surface 14 (stop S2) and the optical axis is 2.366 mm.
Maximum distance between the optical effective area of Surface 17 (stop S3) and the optical axis is 2.440 mm.

TABLE 5B
Aspheric Coefficients

| Surface # | 1 | 2 | 6 | 7 |
|---|---|---|---|---|
| k= | −1.35196E+00 | −6.74800E+00 | −1.22843E−03 | 0.00000E+00 |
| A4= | −3.6356048E−04 | −5.0438298E−04 | −1.5421973E−03 | −3.0489899E−03 |
| A6= | 3.6588015E−05 | 4.8247229E−05 | 9.2700228E−06 | 4.6021865E−04 |
| A8= | −2.3932065E−06 | −3.1012487E−06 | −1.7865063E−06 | −1.1170763E−03 |
| A10= | 1.5944316E−07 | 1.8907894E−07 | 1.6005299E−06 | 7.2676954E−04 |
| A12= | −8.9927341E−09 | −1.0254709E−08 | −3.5336671E−07 | −2.1404152E−04 |
| A14= | 3.0695661E−10 | 3.5178624E−10 | 2.3988515E−08 | 3.4642610E−05 |
| A16= | −5.5760078E−12 | −6.4626022E−12 | −7.3885730E−10 | −3.2243390E−06 |
| A18= | 4.2146998E−14 | 4.9186565E−14 | | 1.6291143E−07 |
| A20= | | | | −3.4779451E−09 |
| Surface # | 8 | 9 | 10 | 11 |
| k= | 0.00000E+00 | 4.18871E−03 | 3.39493E−03 | −5.13377E−04 |
| A4= | −1.8068011E−03 | −6.3275154E−03 | −6.5349981E−03 | −8.8043074E−05 |
| A6= | 1.3085202E−03 | −2.2405738E−03 | −9.6282337E−03 | −8.3120060E−03 |
| A8= | −3.0755555E−03 | 1.6155795E−03 | 7.6451962E−03 | 4.5123416E−03 |
| A10= | 1.8568891E−03 | −1.6091649E−03 | −3.0456708E−03 | −8.2852975E−05 |
| A12= | −5.5509522E−04 | 1.1351040E−03 | 9.7673105E−04 | −7.2559687E−04 |
| A14= | 9.5183120E−05 | −4.5002644E−04 | −2.6426420E−04 | 3.3623774E−04 |
| A16= | −9.5770299E−06 | 1.0408361E−04 | 5.3577481E−05 | −7.7687956E−05 |
| A18= | 5.2844463E−07 | −1.4170133E−05 | −7.2763331E−06 | 1.0127432E−05 |
| A20= | −1.2388389E−08 | 1.0596482E−06 | 5.7877531E−07 | −7.0496570E−07 |
| A22= | | −3.3709366E−08 | −2.0108101E−08 | 2.0326163E−08 |
| Surface # | 12 | 13 | 15 | 16 |
| k= | 0.00000E+00 | 0.00000E+00 | 0.00000E+00 | 0.00000E+00 |
| A4= | 8.4450349E−03 | 7.0137593E−03 | −7.8560322E−03 | −7.3292725E−03 |
| A6= | −3.2314029E−03 | −2.3671677E−03 | −5.8769951E−04 | −2.4209378E−04 |
| A8= | 1.4389747E−03 | 9.8095292E−04 | 1.9855140E−04 | 1.1561257E−04 |
| A10= | −4.0944290E−04 | −2.5057095E−04 | −5.9446903E−05 | −2.0659777E−05 |
| A12= | 7.7506765E−05 | 4.0250381E−05 | 1.3612313E−05 | 1.9167836E−06 |
| A14= | −9.4200135E−06 | −3.7256629E−06 | −2.3386264E−06 | −1.2021506E−07 |
| A16= | 6.5469619E−07 | 1.5147718E−07 | 2.1730020E−07 | 4.5077986E−09 |
| A18= | −1.9163494E−08 | | −8.0546303E−09 | |

According to the Table 5A, the values of f, Fno, HFOV, D0, D4 and D17 at the 1st state and at the 2nd state of the imaging optical lens assembly according to the 5th embodiment are shown in Table 5C.

TABLE 5C
5th Embodiment

| State | 1st | 2nd |
|---|---|---|
| f (mm) | 20.63 | 20.49 |
| Fno | 2.70 | 2.84 |
| HFOV (deg.) | 10.9 | 10.5 |
| D0 | Infinity | 800.000 |
| D4 | 2.744 | 2.103 |
| D17 | 5.732 | 6.373 |

According to the 5th embodiment, the second lens element E2 to the sixth lens element E6 can be moved along the optical axis relative to the image sensor IS so as to focus corresponding to the variation of the object distance, but will not be limited thereto. The details can be similar to the 1st embodiment, and will not be stated again herein.

In the 5th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 5th embodiment, so an explanation in this regard will not be provided again.

Moreover, these parameters can be calculated from Table 5A, Table 5B and Table 5C as the following values and satisfy the following conditions in Table 5D:

TABLE 5D
5th Embodiment

| | 1st state | 2nd state | | 1st state | 2nd state |
|---|---|---|---|---|---|
| V2/V3 | 2.19 | 2.19 | \|f/R5\| | 0.34 | 0.34 |
| (T34 + T45)/T56 | 0.57 | 0.57 | f/R6 | 6.18 | 6.14 |
| CT4/CT3 | 0.73 | 0.73 | f/R8 | 3.31 | 3.29 |
| Dr1r4/CT3 | 22.33 | 21.27 | f1/f3 | −9.71 | −9.71 |
| Dr1r4/Dr5r12 | 1.88 | 1.79 | f2/R3 | 1.80 | 1.80 |
| \|R6/R5\| | 0.06 | 0.06 | f5/CT5 | 24.57 | 24.57 |
| R7/\|f4\| | 0.18 | 0.18 | f5/f3 | −2.69 | −2.69 |
| R8/R7 | 1.42 | 1.42 | Y21/ImgH | 0.79 | 0.79 |
| \|f/f6\| | 0.91 | 0.90 | Y21/Y62 | 1.30 | 1.30 |

### 6th Embodiment

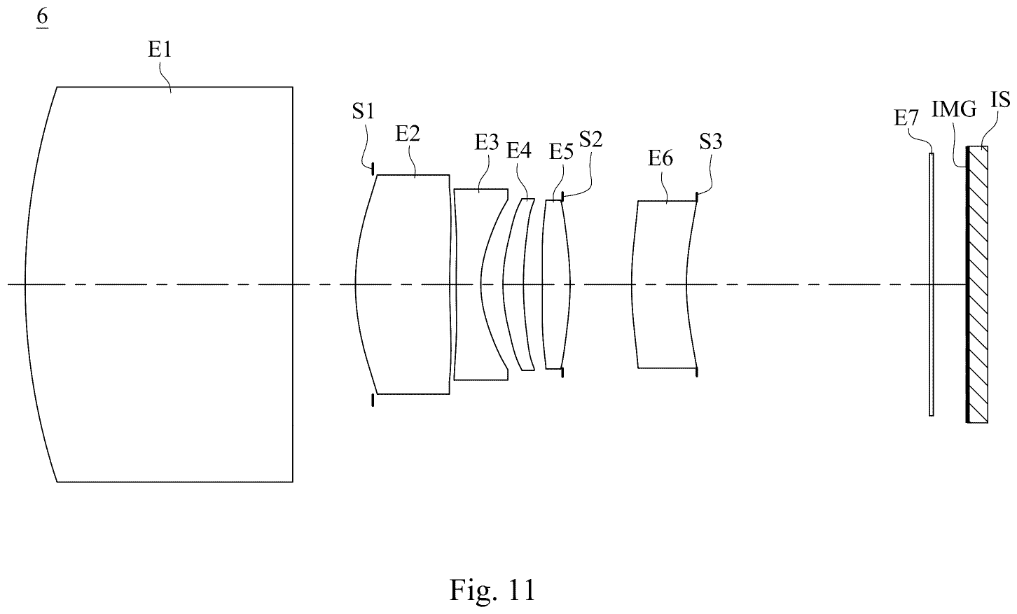

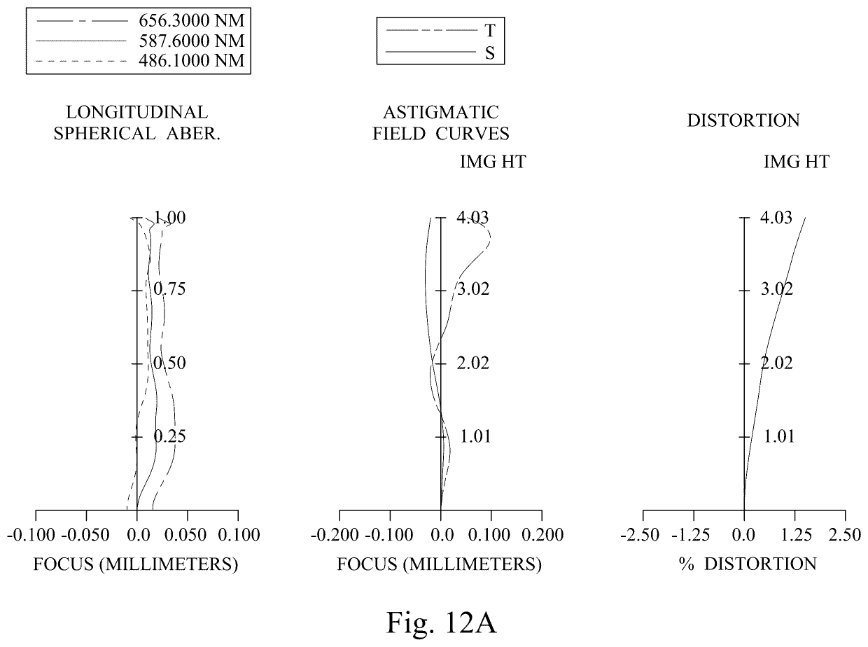

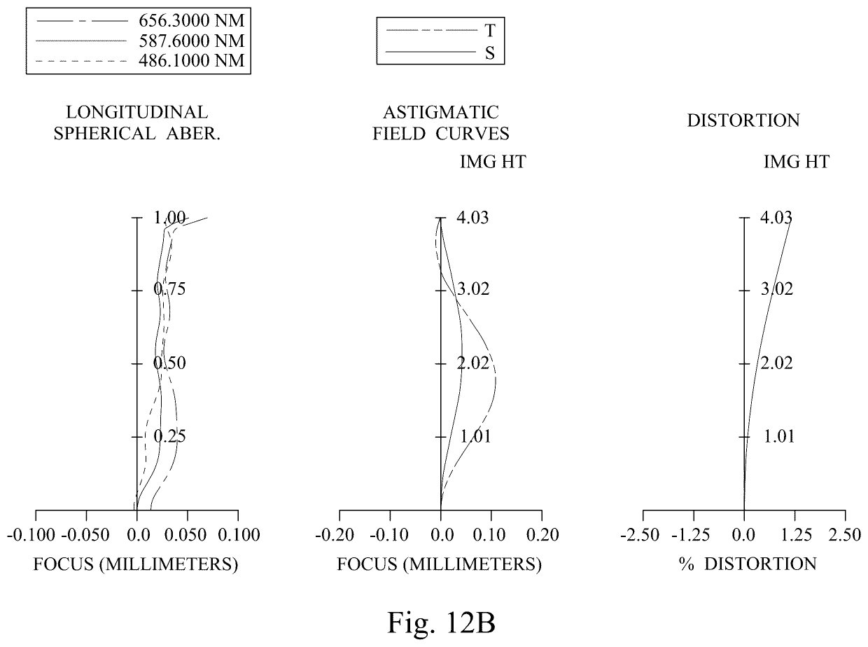

FIG. 11 is a schematic view of an imaging apparatus 6 at the 1st state according to the 6th embodiment of the present disclosure. FIG. 12A shows spherical aberration curves, astigmatic field curves and a distortion curve of the imaging apparatus 6 at the 1st state according to the 6th embodiment. FIG. 12B shows spherical aberration curves, astigmatic field curves and a distortion curve of the imaging apparatus 6 at the 2nd state according to the 6th embodiment. In FIG. 11, the imaging apparatus 6 includes an imaging optical lens assembly (its reference numeral is omitted) and an image sensor IS. The imaging optical lens assembly includes, in order from an object side to an image side along an optical path, a first lens element E1, a stop S1, a second lens element E2, a third lens element E3, a fourth lens element E4, a fifth lens element E5, a stop S2, a sixth lens element E6, a stop S3, a filter E7 and an image surface IMG, wherein the image sensor IS is disposed on the image surface IMG of the imaging optical lens assembly. The imaging optical lens assembly includes six lens elements (E1, E2, E3, E4, E5, E6) without additional one or more lens elements inserted between the first lens element E1 and the sixth lens element E6.

The first lens element E1 with positive refractive power has an object-side surface being convex in a paraxial region thereof and an image-side surface being planar in a paraxial region thereof. The first lens element E1 is made of plastic material. Further, the first lens element E1 is a prism with non-planar surface, which is a light path folding element. The first lens element E1 has a reflective surface located between the object-side surface thereof and the image-side surface thereof along an optical axis, and the first lens element E1 is rotatable relative to the image sensor IS.

The second lens element E2 with positive refractive power has an object-side surface being convex in a paraxial region thereof and an image-side surface being concave in a paraxial region thereof. The second lens element E2 is made of plastic material, and has the object-side surface and the image-side surface being both aspheric. Further, the second lens element E2 includes at least one inflection point in an optical effective area thereof.

The third lens element E3 with negative refractive power has an object-side surface being convex in a paraxial region thereof and an image-side surface being concave in a paraxial region thereof. The third lens element E3 is made of plastic material, and has the object-side surface and the image-side surface being both aspheric. Furthermore, the third lens element E3 includes at least one inflection point in an optical effective area thereof.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Furthermore, the fourth lens element E4 includes at least one inflection point in an optical effective area thereof.

The fifth lens element E5 with positive refractive power has an object-side surface being concave in a paraxial region thereof and an image-side surface being convex in a paraxial region thereof. The fifth lens element E5 is made of plastic material, and has the object-side surface and the image-side surface being both aspheric. Furthermore, the fifth lens element E5 includes at least one inflection point in an optical effective area thereof.

The sixth lens element E6 with negative refractive power has an object-side surface being convex in a paraxial region thereof and an image-side surface being concave in a paraxial region thereof. The sixth lens element E6 is made of plastic material, and has the object-side surface and the image-side surface being both aspheric. Furthermore, the sixth lens element E6 includes at least one inflection point in an optical effective area thereof.

The filter E7 is made of glass material, which is located between the sixth lens element E6 and the image surface IMG in order, and will not affect the focal length of the imaging optical lens assembly.

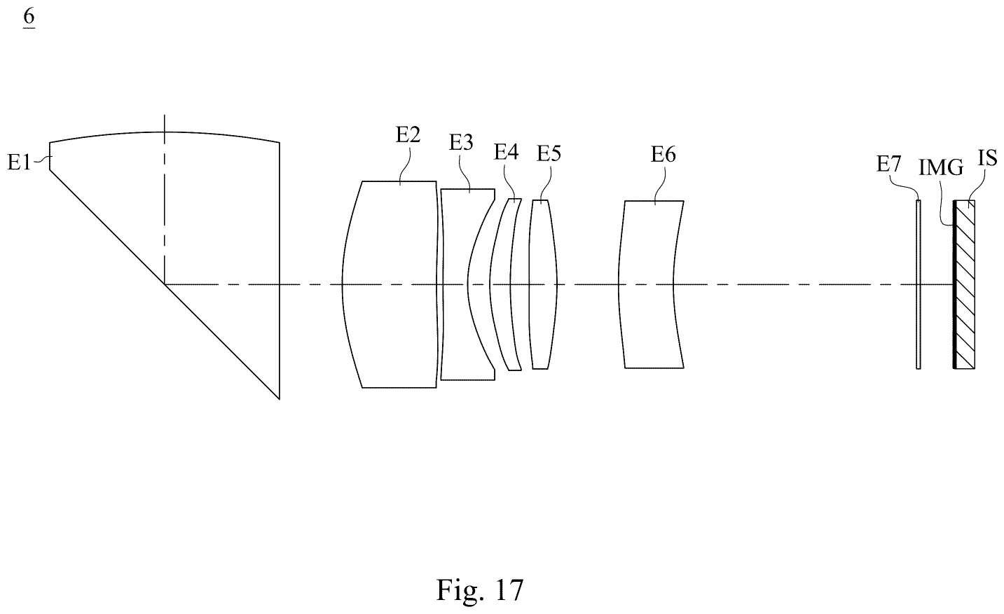

The imaging optical lens assembly can include at least one reflective surface located between the object-side surface of the first lens element E1 and the object-side surface of the second lens element E2 along the optical axis, which can be similar to the reflective surface in the 1st embodiment, and will not be described again herein. According to the 6th embodiment, the reflective surface is disposed on the first lens element E1. FIG. 17 is a schematic view of the folded light path of the imaging apparatus 6 according to the 6th embodiment of the present disclosure. In FIG. 17, the light path is folded via the reflective surface of the first lens element E1, which can be compared to the unfolded light path in FIG. 11.

The reflective surface can be rotatable relative to the image sensor IS (such as roll, pitch, or yaw, etc.), which can compensate the relative variation of the location between the image and the image sensor IS, wherein the rotating method can be adjusted on demand, and the present disclosure will not be limited thereto.

The optical effective area of each surface of each lens element can be non-circular at each state, which can be similar to the 1st embodiment, and will not be stated again herein. According to the 6th embodiment, the optical effective area of the object-side surface of the second lens element E2 is non-circular at both of the 1st state and the 2nd state.

The optical effective area of each stop can be non-circular at each state, which can be similar to the 1st embodiment, and will not be stated again herein. According to the 6th embodiment, the optical effective area of the stop S1 is non-circular at both of the 1st state and the 2nd state.

The detailed optical data of the 6th embodiment are shown in Table 6A and the aspheric surface data are shown in Table 6B below.

TABLE 6A
6th Embodiment

| Surface | | | | | | | Abbe | Focal |
|---|---|---|---|---|---|---|---|---|
| # | | Curvature Radius | | Thickness | Material | Index | # | Length |
| 0 | Object | Plano | | D0 | | | | |
| 1 | Lens 1 | 18.3793 | | 7.800 | Plastic | 1.545 | 56.1 | 33.73 |
| 2 | | Plano | | D2 | | | | |
| 3 | Stop | Plano | | −0.509 | | | | |
| 4 | Lens 2 | 6.9104 | ASP | 2.750 | Plastic | 1.545 | 56.1 | 15.52 |
| 5 | | 32.5165 | ASP | 0.190 | | | | |
| 6 | Lens 3 | 99.9183 | ASP | 0.717 | Plastic | 1.639 | 23.5 | −5.52 |
| 7 | | 3.3973 | ASP | 0.646 | | | | |
| 8 | Lens 4 | 5.0010 | ASP | 0.597 | Plastic | 1.544 | 56.0 | 17.23 |
| 9 | | 10.2693 | ASP | 0.551 | | | | |
| 10 | Lens 5 | −59.1225 | ASP | 0.811 | Plastic | 1.660 | 20.4 | 13.35 |
| 11 | | −7.7081 | ASP | −0.220 | | | | |
| 12 | Stop | Plano | | 2.013 | | | | |
| 13 | Lens 6 | 10.8695 | ASP | 1.600 | Plastic | 1.544 | 56.0 | −52.04 |
| 14 | | 7.4469 | ASP | 0.302 | | | | |

| | | | | | | | |
|---|---|---|---|---|---|---|---|
| 15 | Stop | Plano | D15 | | | | |
| 16 | Filter | Plano | 0.110 | Glass | 1.517 | 64.2 | — |
| 17 | | Plano | 1.002 | | | | |
| 18 | Image | Plano | — | | | | |

Reference wavelength is 587.6 nm (d-line).
L1 has reflective surface (in the 6th embodiment, L1 is a prism with non-planar surface).
Maximum distance between the optical effective area of Surface 3 (stop S1) and the optical axis is 3.213 mm.
Maximum distance between the optical effective area of Surface 12 (stop S2) and the optical axis is 2.444 mm.
Maximum distance between the optical effective area of Surface 15 (stop S3) and the optical axis is 2.430 mm.

TABLE 6B
Aspheric Coefficients

| Surface # | 4 | 5 | 6 | 7 |
|---|---|---|---|---|
| k= | 0.00000E+00 | 0.00000E+00 | 0.00000E+00 | 0.00000E+00 |
| A4= | −9.0815947E−04 | 1.2359561E−02 | 1.8991647E−02 | 1.1129511E−02 |
| A6= | 4.6912879E−05 | −1.3555870E−02 | −2.4440472E−02 | −2.2159238E−02 |
| A8= | −3.0154857E−05 | 6.0145190E−03 | 1.2355310E−02 | 1.2403092E−02 |
| A10= | 6.0433280E−06 | −1.6077643E−03 | −3.7017263E−03 | −4.4681751E−03 |
| A12= | −7.4696691E−07 | 2.9491769E−04 | 7.3816572E−04 | 1.1427676E−03 |
| A14= | 4.6146248E−08 | −4.0601708E−05 | −1.0248261E−04 | −2.1001614E−04 |
| A16= | −1.1274514E−09 | 4.1193848E−06 | 9.7248289E−06 | 2.6403544E−05 |
| A18= | | −2.6267765E−07 | −5.6540412E−07 | −2.0031273E−06 |
| A20= | | 7.4925241E−09 | 1.4934342E−08 | 6.7725073E−08 |
| Surface # | 8 | 9 | 10 | 11 |
| k= | 0.00000E+00 | 0.00000E+00 | 0.00000E+00 | 0.00000E+00 |
| A4= | 2.7932658E−03 | −1.3223838E−03 | 7.6306208E−03 | 7.3483002E−03 |
| A6= | −5.0076891E−03 | 7.0943125E−04 | −1.2846561E−03 | −1.4530633E−03 |
| A8= | 1.6109671E−03 | −1.3498382E−04 | 1.3882027E−03 | 9.7637884E−04 |
| A10= | −5.7650642E−04 | −2.6854690E−04 | −7.4881211E−04 | −4.2411430E−04 |
| A12= | 1.7300031 E−04 | 1.1683681E−04 | 1.8601436E−04 | 8.9987720E−05 |
| A14= | −2.8234563E−05 | −1.5783508E−05 | −2.2862233E−05 | −9.3977305E−06 |
| A16= | 2.3510434E−06 | 6.7974546E−07 | 1.2581030E−06 | 3.8107901E−07 |
| A18= | −8.4649261E−08 | | −2.0760473E−08 | |

| Surface # | 13 | 14 |
|---|---|---|
| k= | 0.00000E+00 | 0.00000E+00 |
| A4= | −4.9369650E−04 | −1.4063372E−03 |
| A6= | −1.2403465E−03 | −2.5248894E−03 |
| A8= | 7.6522772E−04 | 2.3675080E−03 |
| A10= | −4.2888552E−04 | −1.4056289E−03 |
| A12= | 1.6647201E−04 | 5.2387242E−04 |
| A14= | −4.1664471E−05 | −1.2199873E−04 |
| A16= | 6.3636676E−06 | 1.7199571E−05 |
| A18= | −5.3618378E−07 | −1.3403852E−06 |
| A20= | 1.9030846E−08 | 4.4267059E−08 |

According to the Table 6A, the values of f, Fno, HFOV, D0, D2 and D15 at the 1st state and at the 2nd state of the imaging optical lens assembly according to the 6th embodiment are shown in Table 6C, wherein D2 is the central thickness of surface 2, D15 is the central thickness of surface 15.

TABLE 6C
6th Embodiment

| State | 1st | 2nd |
|---|---|---|
| f (mm) | 20.71 | 20.50 |
| Fno | 2.53 | 2.70 |
| HFOV (deg.) | 10.8 | 10.5 |
| D0 | Infinity | 800.000 |
| D2 | 2.340 | 1.463 |
| D15 | 6.787 | 7.664 |

According to the 6th embodiment, the second lens element E2 to the sixth lens element E6 can be moved along the optical axis relative to the image sensor IS so as to focus corresponding to the variation of the object distance, but will not be limited thereto. The details can be similar to the 1st embodiment, and will not be stated again herein.

In the 6th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 6th embodiment, so an explanation in this regard will not be provided again.

Moreover, these parameters can be calculated from Table 6A, Table 6B and Table 6C as the following values and satisfy the following conditions in Table 6D:

TABLE 6D
6th Embodiment

| | 1st state | 2nd state | | 1st state | 2nd state |
|---|---|---|---|---|---|
| V2/V3 | 2.39 | 2.39 | \|f/R5\| | 0.21 | 0.21 |
| (T34 + T45)/T56 | 0.67 | 0.67 | f/R6 | 6.10 | 6.03 |
| CT4/CT3 | 0.83 | 0.83 | f/R8 | 2.02 | 2.00 |
| Dr1r4/CT3 | 17.27 | 16.04 | f1/f3 | −6.11 | −6.11 |
| Dr1r4/Dr5r12 | 1.84 | 1.71 | f2/R3 | 2.25 | 2.25 |
| \|R6/R5\| | 0.03 | 0.03 | f5/CT5 | 16.46 | 16.46 |
| R7/\|f4\| | 0.29 | 0.29 | f5/f3 | −2.42 | −2.42 |
| R8/R7 | 2.05 | 2.05 | Y21/ImgH | 0.79 | 0.79 |
| \|f/f6\| | 0.40 | 0.39 | Y21/Y62 | 1.32 | 1.32 |

### 7th Embodiment

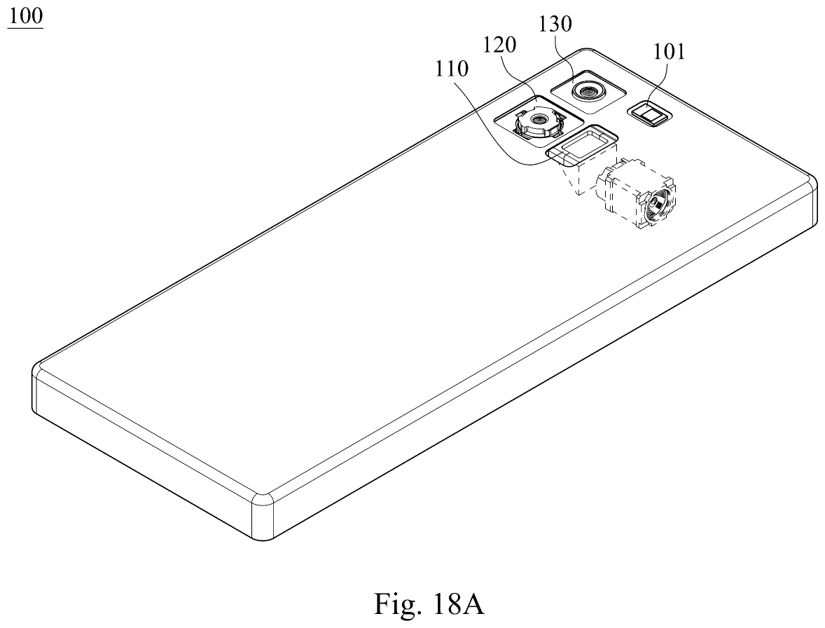

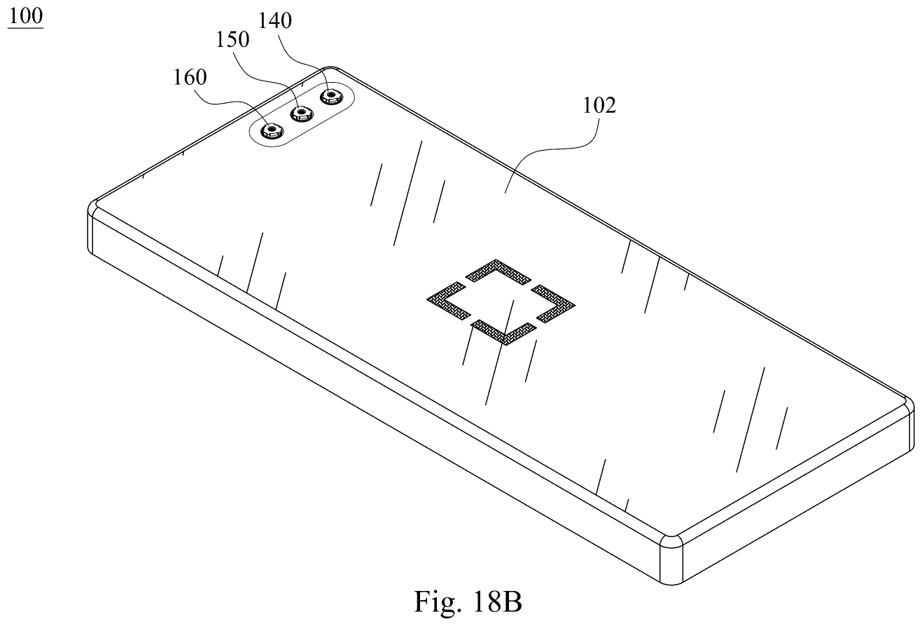

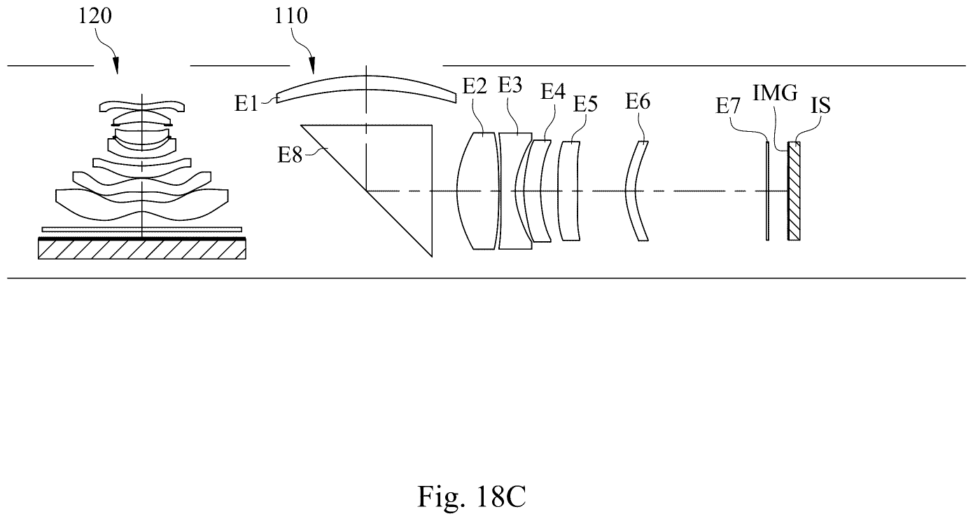

FIG. 18A is a schematic view of one side of an electronic device 100 according to the 7th embodiment of the present disclosure. FIG. 18B is a schematic view of another side of the electronic device 100 of FIG. 18A. FIG. 18C is a system schematic view of the electronic device 100 of FIG. 18A. In FIGS. 18A, 18B and 18C, the electronic device 100 according to the 7th embodiment is a smartphone, which include imaging apparatuses 110, 120, 130, 140, 150, 160, a flash module 101, a focusing assisting module, an image signal processor (ISP), a user interface 102 and an image software processor, wherein each of the imaging apparatuses 140, 150, 160 is a front camera.

The imaging apparatus 110 includes an imaging lens assembly, a driving apparatus, an image sensor IS and an image stabilization module, wherein the imaging lens assembly includes the imaging optical lens assembly according to the present disclosure, a barrel and a holder member for holding the imaging optical lens assembly. It should be mentioned that the imaging optical lens assembly includes a light path folding element E8, which has a reflective surface. The light path folding element E8 can be a prism, but will not be limited thereto. The imaging apparatus 110 can focus light from an imaged object via the imaging lens assembly, perform image focusing by the driving apparatus, and generate an image on the image sensor, and the imaging information can be transmitted.

The driving apparatus can have the functions, such as focal length adjustment, etc., which can drive by the driving systems, such as screw, voice coil motor (VCM), which can be spring type or ball type, micro electro-mechanical systems (MEMS), piezoelectric, or shape memory alloy, etc. The imaging optical lens assembly can obtain better image position via the driving apparatus, so that it is favorable for obtaining clear images of the object under different object distances. Further, at least one lens element of the imaging optical lens assembly can be movable relative the image sensor IS along the optical axis via the driving apparatus, so that the effects, such as zoom or focusing, etc., can be achieved. Also, the reflective surface can be rotatable relative to the image sensor (such as roll, pitch, or yaw, etc.) via the driving apparatus, so that it is favorable for compensating the relative variation of the location between the image and the image sensor so as to achieve the effects, such as optical image stabilizations, etc.

The imaging apparatus 110 can include the image sensor IS located on the image surface of the imaging optical lens assembly, such as CMOS and CCD, with superior photosensitivity and low noise. Thus, it is favorable for providing realistic images with high definition image quality thereof. Moreover, the imaging apparatus 110 can further include an image stabilization module, which can be a motion sensor, such as an accelerometer, a gyro sensor, and a Hall effect sensor. Therefore, the variation of different axial directions of the imaging optical lens assembly can adjusted so as to compensate the image blur generated by motion at the moment of exposure, and it is further favorable for enhancing the image quality while photographing in motion and low light situation. Furthermore, advanced image compensation functions, such as optical image stabilizations (OIS) and electronic image stabilizations (EIS) etc., can be provided.

When the user captures images of an imaged object via the user interface 102, the electronic device 100 focuses and generates an image via at least one of the imaging apparatuses 110, 120, 130, 140, 150 or 160 while compensating for low illumination via the flash module 101 when necessary. Then, the electronic device 100 quickly focuses on the imaged object according to its object distance information provided by the focusing assisting module, and optimizes the image via the image signal processor and the image software processor. Thus, the image quality can be further enhanced. The focusing assisting module can adopt conventional infrared or laser for obtaining quick focusing, and the user interface 102 can utilize a touch screen or a physical button for capturing and processing the image with various functions of the image processing software.

Each of the imaging apparatuses 120, 130, 140, 150, 160 can include the imaging optical lens assembly of the present disclosure, and can be the same or similar to the imaging apparatus 110, and will not describe again herein. In detail, the imaging apparatuses 110, 120, 130 can be telephoto imaging apparatus (including a light path folding element), wide angle imaging apparatus and ultra-wide angle imaging apparatus, respectively. The imaging apparatuses 140, 150, 160 can be wide angle imaging apparatus, ultra-wide angle imaging apparatus and TOF (Time-Of-Flight) module, respectively, or can be others imaging apparatuses, which will not be limited thereto. Further, in FIG. 18C, each of the elements in the imaging apparatus 110 can be the same or similar to any one numeral of the corresponding element according to the 1st embodiment to the 6th embodiment, which will not be shown and detailed descripted again.

### 8th Embodiment

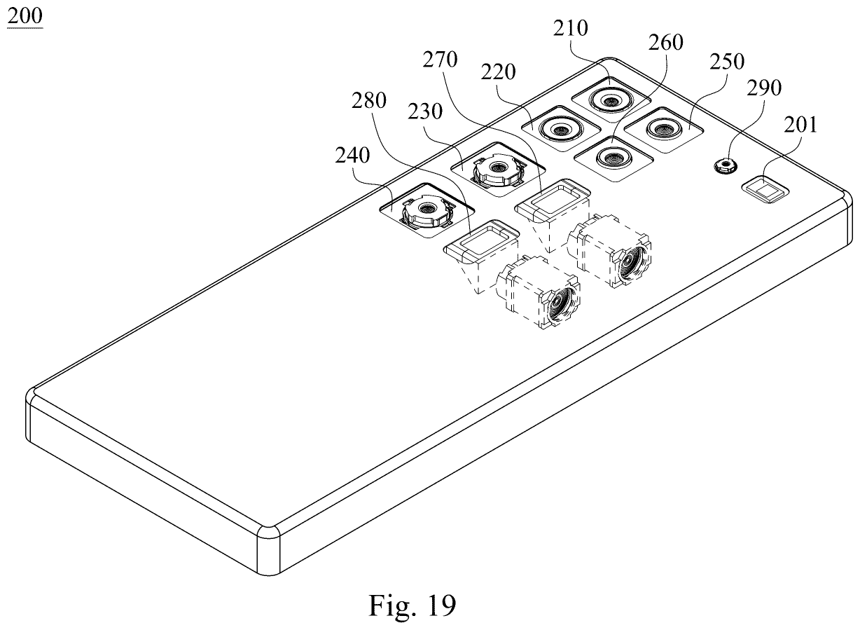

FIG. 19 is a schematic view of one side of an electronic device 200 according to the 8th embodiment of the present disclosure. According to the 8th embodiment, the electronic device 200 is a smartphone, which include imaging apparatuses 210, 220, 230, 240, 250, 260, 270, 280, 290 and a flash module 201.

The electronic device 200 according to the 8th embodiment can include the same or similar elements to that according to the 7th embodiment, and each of the imaging apparatuses 210, 220, 230, 240, 250, 260, 270, 280, 290 and the flash module 201 can have a configuration which is the same or similar to that according to the 7th embodiment, and will not describe again herein. In detail, according to the 8th embodiment, each of the imaging apparatuses 210, 220, 230, 240, 250, 260, 270, 280, 290 can include the imaging optical lens assembly of the present disclosure, and can be the same or similar to the imaging apparatus 110 according to the aforementioned 7th embodiment, and will not describe again herein.

In detail, each of the imaging apparatuses 210, 220 can be ultra-wide angle imaging apparatus, each of the imaging apparatuses 230, 240 can be wide angle imaging apparatus, each of the imaging apparatuses 250, 260 can be telephoto imaging apparatus, each of the imaging apparatuses 270, 280 can be telephoto imaging apparatus (which can include light path folding element), the imaging apparatus 290 can be TOF module, or can be adaptively adjusted according to the type of the imaging apparatuses, which will not be limited to the arrangement.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging optical lens assembly comprising six lens elements, the six lens elements, in order from an object side to an image side along an optical path:
a first lens element, a second lens element, a third lens element, a fourth lens element, a fifth lens element and a sixth lens element; each of the sixth lens elements has an object-side surface towards the object side and an image-side surface towards the image side;
wherein the object-side surface of the first lens element is convex in a paraxial region thereof;
the second lens element has positive refractive power;
the image-side surface of the third lens element is concave in a paraxial region thereof;
the object-side surface of the fourth lens element is convex in a paraxial region thereof, the image-side surface of the fourth lens element is concave in a paraxial region thereof;
at least one of the second lens element to the sixth lens element comprises at least one inflection point in an optical effective area thereof;
wherein an axial distance between the third lens element and the fourth lens element is T34, an axial distance between the fourth lens element and the fifth lens element is T45, an axial distance between the fifth lens element and the sixth lens element is T56, an axial distance between the object-side surface of the first lens element and the image-side surface of the second lens element of the imaging optical lens assembly is Dr1r4, a central thickness of the third lens element is CT3, a focal length of the imaging optical lens assembly is f, a curvature radius of the image-side surface of the third lens element is R6, and the following conditions are satisfied:
$$\begin{matrix}0.1 < ( T 34 + T 45 ) / T 56 < 1.6 ; \\ 6.5 < Dr 1 r 4 / CT 3 ; and \\ 4.4 < f / R 6.\end{matrix}$$

2. The imaging optical lens assembly of claim 1, wherein the axial distance between the third lens element and the fourth lens element is T34, the axial distance between the fourth lens element and the fifth lens element is T45, the axial distance between the fifth lens element and the sixth lens element is T56, and the following condition is satisfied:
$$0.3 < ( T 34 + T 45 ) / T 56 < 1.4 .$$

3. The imaging optical lens assembly of claim 1, wherein an Abbe number of the second lens element is V2, an Abbe number of the third lens element is V3, and the following condition is satisfied:
$$1.95 < V 2 / V 3 < 3.5 .$$

4. The imaging optical lens assembly of claim 1, wherein the axial distance between the object-side surface of the first lens element and the image-side surface of the second lens element of the imaging optical lens assembly is Dr1r4, an axial distance between the object-side surface of the third lens element and the image-side surface of the sixth lens element of the imaging optical lens assembly is Dr5r12, and the following condition is satisfied:
$$1.6 < Dr 1 r 4 / Dr 5 r 12 < 2.3 .$$

5. The imaging optical lens assembly of claim 1, wherein a curvature radius of the object-side surface of the third lens element is R5, a curvature radius of the object-side surface of the fourth lens element is R7, the focal length of the imaging optical lens assembly is f, a focal length of the fourth lens element is f4, and the following conditions are satisfied:
$$0 < R 7 / \vert f 4 \vert < 0.55 ; and$$
$$\vert f / R 5 \vert < 0.6 .$$

6. The imaging optical lens assembly of claim 1, wherein an f-number of the imaging optical lens assembly is Fno, a maximum distance between an optical effective area of the object-side surface of the second lens element and an optical axis is Y21, a maximum image height of the imaging optical lens assembly is ImgH, and the following conditions are satisfied:
$$2. < Fno < 3.3 ; and$$
$$0.6 < Y 21 / ImgH < 1. .$$

7. An imaging apparatus, comprising:
the imaging optical lens assembly of claim 1; and
an image sensor disposed on an image surface of the imaging optical lens assembly.

8. The imaging apparatus of claim 7, wherein at least one of the six lens elements is movable relative to the image sensor along an optical axis.

9. An electronic device, comprising:
the imaging apparatus of claim 7.

10. An imaging optical lens assembly comprising six lens elements, the six lens elements, in order from an object side to an image side along an optical path:
a first lens element, a second lens element, a third lens element, a fourth lens element, a fifth lens element and a sixth lens element; each of the sixth lens elements has an object-side surface towards the object side and an image-side surface towards the image side;
wherein the object-side surface of the first lens element is convex in a paraxial region thereof;
the object-side surface of the second lens element is convex in a paraxial region thereof;
the image-side surface of the third lens element is concave in a paraxial region thereof;
the object-side surface of the fourth lens element is convex in a paraxial region thereof, the image-side surface of the fourth lens element is concave in a paraxial region thereof;
at least one of the second lens element to the sixth lens element comprises at least one inflection point in an optical effective area thereof;
wherein an axial distance between the third lens element and the fourth lens element is T34, an axial distance between the fourth lens element and the fifth lens element is T45, an axial distance between the fifth lens element and the sixth lens element is T56, an axial distance between the object-side surface of the first lens element and the image-side surface of the second lens element of the imaging optical lens assembly is Dr1r4, a central thickness of the third lens element is CT3, a focal length of the imaging optical lens assembly is f, a curvature radius of the image-side surface of the third lens element is R6, and the following conditions are satisfied:
$$0.1 < ( T 34 + T 45 ) / T 56 < 1.6 ;$$
$$6.5 < Dr 1 r 4 / CT 3 ; and$$
$$4.4 < f / R 6.$$

11. The imaging optical lens assembly of claim 10, wherein the axial distance between the object-side surface of the first lens element and the image-side surface of the second lens element of the imaging optical lens assembly is Dr1r4, the central thickness of the third lens element is CT3, the focal length of the imaging optical lens assembly is f, the curvature radius of the image-side surface of the third lens element is R6, and the following conditions are satisfied:
$$9. < Dr 1 r 4 / CT 3 < 45 ; and$$
$$4.9 < f / R 6 < 8.0 .$$

12. The imaging optical lens assembly of claim 11, wherein the axial distance between the third lens element and the fourth lens element is T34, the axial distance between the fourth lens element and the fifth lens element is T45, the axial distance between the fifth lens element and the sixth lens element is T56, the axial distance between the object-side surface of the first lens element and the image-side surface of the second lens element of the imaging optical lens assembly is Dr1r4, the central thickness of the third lens element is CT3, a central thickness of the fourth lens element is CT4, the focal length of the imaging optical lens assembly is f, the curvature radius of the image-side surface of the third lens element is R6, and the following conditions are satisfied:
$$0.47 \leq ( T 34 + T 45 ) / T 56 \leq 1.24 ;$$
$$13.8 \leq Dr 1 r 4 / CT 3 \leq 24 \text{.06} ;$$
$$5.42 \leq f / R 6 \leq 6.25 ; and$$
$$0.68 \leq CT 4 / CT 3 \leq 1.16 .$$

13. The imaging optical lens assembly of claim 10, wherein the focal length of the imaging optical lens assembly is f, a curvature radius of the image-side surface of the fourth lens element is R8, and the following condition is satisfied:
$$1.1 < f / R 8 < 4.5 .$$

14. The imaging optical lens assembly of claim 10, wherein the second lens element has positive refractive power; the focal length of the imaging optical lens assembly is f, a focal length of the second lens element is f2, a focal length of the sixth lens element is f6, a curvature radius of the object-side surface of the second lens element is R3, and the following conditions are satisfied:
$$1.3 < f 2 / R 3 < 3. ; and$$
$$\vert f / f 6 \vert < 1.1 .$$

15. The imaging optical lens assembly of claim 10, wherein an optical effective area of at least one surface of at least one of the first lens element to the sixth lens element is non-circular; the imaging optical lens assembly further comprises a stop, which has an optical effective area being non-circular.

16. An imaging optical lens assembly comprising six lens elements, the six lens elements, in order from an object side to an image side along an optical path:
a first lens element, a second lens element, a third lens element, a fourth lens element, a fifth lens element and a sixth lens element; each of the sixth lens elements has an object-side surface towards the object side and an image-side surface towards the image side;
wherein the object-side surface of the first lens element is convex in a paraxial region thereof;
the object-side surface of the second lens element is convex in a paraxial region thereof;
the third lens element has negative refractive power;
the object-side surface of the fourth lens element is convex in a paraxial region thereof, the image-side surface of the fourth lens element is concave in a paraxial region thereof;
at least one of the second lens element to the sixth lens element comprises at least one inflection point in an optical effective area thereof;
wherein an axial distance between the third lens element and the fourth lens element is T34, an axial distance between the fourth lens element and the fifth lens element is T45, an axial distance between the fifth lens element and the sixth lens element is T56, an axial distance between the object-side surface of the first lens element and the image-side surface of the second lens element of the imaging optical lens assembly is Dr1r4, a central thickness of the third lens element is CT3, a central thickness of the fourth lens element is CT4, and the following conditions are satisfied:
$$0.1 < ( T 34 + T 45 ) / T 56 < 1.6 ;$$
$$11 < Dr 1 r 4 / CT 3 < 45 ; and$$
$$0.1 < CT 4 / CT 3 < 1.7 .$$

17. The imaging optical lens assembly of claim 16, wherein the central thickness of the third lens element is CT3, the central thickness of the fourth lens element is CT4, and the following condition is satisfied:
$$0.4 < CT 4 / CT 3 < 1.4 .$$

18. The imaging optical lens assembly of claim 16, wherein a curvature radius of the object-side surface of the third lens element is R5, a curvature radius of the image-side surface of the third lens element is R6, and the following condition is satisfied:
$$\vert R 6 / R 5 \vert < 0.16 .$$

19. The imaging optical lens assembly of claim 16, wherein a curvature radius of the object-side surface of the fourth lens element is R7, a curvature radius of the image-side surface of the fourth lens element is R8, and the following condition is satisfied:
$$0. 85 < R 8 / R 7 < 3.0 .$$

20. The imaging optical lens assembly of claim 16, wherein half of a maximum field of view of the imaging optical lens assembly is HFOV, a maximum distance between an optical effective area of the object-side surface of the second lens element and an optical axis is Y21, a maximum distance between an optical effective area of the image-side surface of the sixth lens element and the optical axis is Y62, and the following conditions are satisfied:
5.0 degrees<HFOV<20.0 degrees; and
$$1.1 < Y 21 / Y 62 < 1.5 .$$

21. The imaging optical lens assembly of claim 16, wherein the first lens element has positive refractive power; a focal length of the first lens element is f1, a focal length of the third lens element is f3, and the following condition is satisfied:
$$- 16 < f 1 / f 3 < - 5.0 .$$

22. The imaging optical lens assembly of claim 16, wherein the fifth lens element has positive refractive power; a focal length of the fifth lens element is f5, a central thickness of the fifth lens element is CT5, and the following condition is satisfied:
$$6. < f 5 / CT 5 < 90 .$$

23. The imaging optical lens assembly of claim 16, wherein the fifth lens element has positive refractive power; a focal length of the third lens element is f3, a focal length of the fifth lens element is f5, and the following condition is satisfied:
$$- 15 < f 5 / f 3 < - 1.2 .$$

24. The imaging optical lens assembly of claim 16, further comprising:
at least one reflective surface located between the object-side surface of the first lens element and the object-side surface of the second lens element along an optical axis.
